(19) United States
(12) Patent Application Publication
(10) Pub. No.: US 2005/0151011 A1
(43) Pub. Date: Jul. 14, 2005

(54) Method and system for controlling the operation of a valve

(75) Inventors: Peter Tartaglia, Butler, NJ (US); Mihai Ralea, Boonton Township, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Marotta Controls, Inc., Montville, NJ (US)

(21) Appl. No.: 10/826,545

(22) Filed: Apr. 16, 2004

Related U.S. Application Data
(62) Division of application No. 10/354,339, filed on Jan. 30, 2003, now abandoned.
(60) Provisional application No. 60/354,054, filed on Jan. 31, 2002.
(60) Provisional application No. 60/376,094, filed on Apr. 26, 2002.

(51) Int. Cl. B64C 25/00

(52) U.S. Cl. 244/110 A

(57) ABSTRACT

A speed reduction system for decreasing the speed of a moving craft has a craft engaging device, a control mechanism, and a hydraulic energy transfer system adapted to transmit energy from the craft engaging device to the control mechanism. The control mechanism is adapted to actively control release of energy from the hydraulic energy transfer system during the decrease of the speed of the craft. A method of controlling the operation of a valve includes adjusting the valve during the operation of the valve after comparing a condition to a desired condition determined by a profile. A hydraulic valve has a valve member defining passages arranged to balance the force of the fluid pressure acting on the valve member and an actuator connected to the valve member. A valve control system includes a controller and a driver arranged with the controller. The position of the valve is adjusted during a predetermined cycle to control the operation of the valve.

### CROSS-REFERENCE TO RELATED APPLICATIONS

This application is a divisional application of U.S. application Ser. No. 10/354,339 filed on Jan. 30, 2003, which claims the benefit of U.S. Provisional Application No. 60/354,054, filed Jan. 31, 2002, and U.S. Provisional Application No. 60/376,094, filed Apr. 26, 2002, the disclosures of which are both hereby incorporated by reference herein.

### FIELD OF THE INVENTION

The present invention relates to systems for decreasing the speed of a moving craft, as well as to methods and apparatus for controlling the operation of such systems and for controlling the operation of any valve.

### BACKGROUND OF THE INVENTION

A schematic of a prior art system for arresting a moving craft on an aircraft carrier is shown in FIG. 1. A deck pendant 10 extends across the deck of the aircraft carrier. As an aircraft 14 approaches for a landing, a tail hook from the aircraft engages the pendant 10 on the deck 12 of the aircraft carrier (see FIG. 2).

The pendant 10 is connected to a system 16 located beneath the deck 12 for resisting movement of the pendant 10 when it is attached to a landing aircraft 14. The system 16 includes a hydraulic system 18, best seen in FIGS. 1 and 3, having a conduit 30 connected to a cylinder 22 that receives a ram 24. The ram is connected to the pendant 10 and arranged in the cylinder 22 so that, as the pendant 10 is drawn out by the landing aircraft 14, the ram 24 applies pressure to the fluid in the cylinder 22. The fluid moves through the hydraulic system 18 to the inlet 28 of a valve 26.

As shown in FIG. 3, the valve 26 has a poppet 40 for opening and closing the valve 26 and a cam 36. The cam 36 applies a force to the poppet 40, through one or more levers 38, in a hammer-like action. The cam 36, levers 38 and associated parts are not connected to the poppet 40, but contact the poppet 40 periodically, in forcing the poppet closed. During arrestment of an aircraft, the hydraulic fluid forces the poppet 40 open and the operation of the cam 36 periodically forces the poppet 40 shut, but allows the fluid to force the poppet 40 open again. The levers 38 can be manually adjusted prior to the engagement of the pendant 10 by a landing aircraft 14, to change the force applied to the poppet 40. After the fluid exits through the outlet 32 of the valve 26, the fluid travels to an accumulator 34, as shown schematically in FIG. 1. A second, retraction valve 44 is used in returning the pendant 10 back to its starting position on the deck 12 of the aircraft carrier.

Due to the arresting forces required, the pressure of the hydraulic fluid at the inlet 28 of the valve 26 can be up to 10,000 lbs. per square inch or more. This figure depends upon the speed and weight of the craft.

Control systems for the prior art system are located at the pri-fly control center 46, the engine room controls 48, and the deck edge controls 50, as shown in FIG. 2.

Aircraft have become larger and faster since the design of the prior art arrestment system discussed above. In addition, the system described above requires a great deal of maintenance. Due to the hammer-like action in shutting the valve, the parts in the system are subjected to a great deal of wear and tear. The system also relies upon a human operator who determines the adjustment of the levers that is required to arrest a given plane under given conditions. No monitoring of the system during operation is used to control the arrestment sequence. No control or adjustment during an arrestment cycle is possible, due to the lack of a connection between the poppet and the cam and due to the magnitude of the forces on the poppet.

Improvements to speed reduction systems and to valves for such systems are desired.

### SUMMARY OF THE INVENTION

The present invention addresses these needs.

In one aspect of the present invention, a speed reduction system for decreasing the speed of a moving craft comprises a craft engaging device, a control mechanism, and a hydraulic energy transfer system adapted to transmit energy from the craft engaging device to the control mechanism. The control mechanism is adapted to actively control release of energy from the energy transfer system during the decrease of the speed of the craft. For example, the control mechanism may comprise a valve connected to a hydraulic energy transfer system comprising one or more conduits. In such embodiments, the valve throttles the flow of hydraulic fluid through the one or more conduits.

In a preferred embodiment, the control mechanism has a feed-back apparatus including sensors for sensing conditions within the speed reduction system and providing data to be used in controllably releasing energy from the hydraulic energy transfer system during the decrease of the speed of the craft. The feed-back apparatus desirably comprises one or more sensors positioned throughout the system to gather data about one or more of the following conditions: the position of the craft while the speed of the craft is being decreased, the state of the control mechanism, and the state of the energy transfer system. For example, for a system having a valve, the sensors may include fluid pressure sensors. Utilizing data concerning one or more of these conditions, the operation of the control mechanism is controlled while the speed of the craft is decreased.

In a preferred embodiment, the system includes a controller arranged to utilize the data provided by the feed-back apparatus to control the operation of the control mechanism during the decrease of the speed of the craft.

In a preferred embodiment, the energy transfer system comprises at least one conduit containing hydraulic fluid. The hydraulic fluid is desirably a substantially incompressible fluid for transferring energy from the craft engaging device to the control mechanism. The fluid may comprise water, oil or other fluids known to those of ordinary skill in the art. One of the sensors for sensing conditions within the speed reduction system desirably senses the pressure of the hydraulic fluid within the at least one conduit.

In certain embodiments, a ram is connected to the craft-engaging device for applying pressure to the hydraulic fluid. A sensor may sense the position of the ram and may be used to determine the position of the craft.

The craft engaging device may comprise a cable, net, cushion or other device for engaging a craft, such as an aircraft, motor vehicle, ship, boat, rocket, etc.

A conduit of the hydraulic system is desirably connected to the control mechanism. The control mechanism may comprise a valve having a valve member for controlling the flow of the hydraulic fluid within the hydraulic energy transfer system. One of the sensors may be arranged to sense the position of the valve member.

Preferably, the speed reduction system includes a controller comprising a computer having a processor for evaluating a speed reduction cycle according to a predetermined profile determining a desired condition during the cycle. The processor preferably comprises a digital signal processor (“DSP”). A DSP is optimized for making calculations involving many factors.

The computer desirably includes a memory storage device and the processor is arranged to interact with the memory storage device. The memory storage device may be used to store data comprising the profile used in controlling the release of energy from the energy transfer system. The profile desirably determines the desired position of the craft at a given point in time during which the speed of the craft is being decreased. The profile may determine the desired pressure of the hydraulic fluid within the energy transfer system at a given point in time during which the speed of the craft is being decreased. In certain preferred embodiments, the controller determines an adjustment in the operation of the control mechanism to conform the reduction in speed of the craft to the profile.

In certain preferred embodiments, the control mechanism comprises a valve having a valve member and an actuator connected to the valve member. The valve member is desirably arranged with respect to the energy transfer system to substantially balance the forces on the valve member exerted thereupon by the energy transfer system. For example, the valve member may define one or more passages communicating with a balancing chamber arranged to balance the fluid pressure forces on the valve member. A number of means may be used to balance the forces on the valve member. A balancing force or pressure may be supplied from outside the valve and hydraulic system. In moving the valve member, the forces from the hydraulic fluid pressure do not have to be overcome in order to position the valve member. In preferred embodiments, the valve operates substantially independently of the forces exerted thereupon by the hydraulic fluid. A valve having a poppet may be used. However, other types of valves may be used, such as globe valve, gate valve or other known types. In other preferred embodiments, the closure comprises another type of closure commonly used in valves, such as a gate, globe, head or other element for closing or substantially closing an opening.

A driver is desirably arranged to move the valve member while the speed of the craft is decreased. In preferred embodiments, a pair of drivers are arranged so as to be alternately engaged with the valve member. A plurality of sensors are arranged to detect the inoperability of one or both of the drivers. When there is a flow in the data from the sensors for one driver, the system is arranged to operate utilizing the other driver. For example, a preferred embodiment utilizes two drivers and two sensors are provided for each driver. If the data from the two sensors associated with the first driver does not agree, the first driver is not used to move the closure and the second driver is used instead. A controller may be connected to the drivers and arranged so that, in the event that one driver is inoperable, the controller issues commands for engaging the other driver with the valve member. The driver or drivers may comprise one or more motors.

Balancing the forces on the valve results in a number of benefits. The load required to move the valve member can be dramatically reduced. With the load reduced, a mechanical connection, such as a gear train, can be made to the valve member and a motor may be used to operate the valve closure. In an embodiment for arresting an aircraft, control over the position of the valve may be exercised during arrestment of a craft. A feedback system may be used to sense the position of the aircraft during arrestment and the valve member may be positioned accordingly. The stored power required to operate the system is reduced. In an embodiment for arresting an aircraft landing on an aircraft carrier, the system can be operated using ship emergency power.

In a further aspect of the present invention, a method controlling operation of a valve comprises automatically determining a condition; automatically comparing the condition to a desired condition determined by a profile; automatically determining an adjustment to the valve; and adjusting the valve during the operation of the valve. Desirably, the adjustment substantially conforms the position of the craft to a desired position determined by the profile.

In methods according to embodiments of the invention, the speed of a craft may be reduced without requiring inputting of data for the speed of the incoming craft, the weight of the craft, or other factors. A sensor is used to sense the position of the craft as the craft's speed is being decreased and an adjustment to a control mechanism that will decrease the speed of the craft according to a given profile is determined. In other embodiments, the position of the craft is determined theoretically, according to a model. The model determines the position of the craft for a given craft speed, craft weight, and other factors. Then, the appropriate adjustments to the control mechanism are determined based upon the model.

The step of automatically determining a condition may comprise determining a state of the valve. In certain embodiments, the valve has a valve member and the position of the valve member is sensed. A sensor may be used to sense the position of the valve member and determine a state of the valve. The position of the valve member is adjusted to a position determined by the profile.

The condition may also comprise the pressure of hydraulic fluid. The pressure may be sensed utilizing a sensor.

In certain preferred embodiments, the profile determines desired conditions for a desired reduction in speed of a moving craft during a predetermined cycle. The step of comparing may comprise comparing the condition to a profile for determining a desired position of the craft at a point during the cycle. The profile may determine the desired conditions for a plurality of points during the cycle for achieving a desired reduction in speed for a predetermined stopping distance. The steps of automatically determining the condition, automatically determining an adjustment and adjusting the valve may comprise repeatedly monitoring the condition, determining an adjustment and adjusting the valve.

The method may include receiving data concerning a value to be used in determining the adjustment. The value may be one or more of the following: the type of craft, the speed of the craft, the weight of the craft, and other factors. In certain preferred embodiments, a profile is selected from a plurality of profiles, based upon one or more values.

Preferably, the operability of the valve is tested. The valve has a valve member and at least one driver. The testing may include moving the closure and operating the driver. The movement of the closure and the operation of the driver may be sensed by a sensor for confirming the operability of these components.

In preferred embodiments, a pair of drivers are associated with the valve and the method further comprises determining the operability of the drivers. If the inoperability of one driver is detected, the other driver is used in operating the closure.

Each of the drivers preferably has a plurality of sensors associated with it for determining the operability of the drivers. The state of the driver is sensed and the values detected by each of the sensors are compared. If the values from the sensors do not agree, then the driver is determined to be inoperable.

In a further aspect of the present invention, a hydraulic valve comprises a housing defining an inlet and an outlet and a valve member movable between a closed position blocking the inlet and an open position, in which the inlet communicates with the outlet. The valve member has a passage defined therein for communicating with a chamber adjacent the valve member. The passage is arranged to balance the force of the fluid pressure acting on the valve member at the inlet. The valve includes an actuator connected to the valve member for moving the valve member.

The inlet is desirably adjacent the outlet and the chamber may be disposed on an opposite side of the valve member from the inlet. The passage may comprise one or more passages that communicate with the inlet. The valve desirably comprises a driver connected to the actuator.

In certain preferred embodiments, the valve member has an inlet-facing surface and a balancing surface opposite the inlet-facing surface. The balancing surface is disposed at the chamber. The surface area of the inlet-facing surface and the balancing surface are desirably sized so as to minimize the force required to move the valve member.

The actuator may comprise a first member and a second member. The first member is connected to the valve member and linearly movable for moving the valve member to a position between the open position and the closed position. The driver may be connected to the second member and the first member may be connected to the second member.

In a preferred embodiment, the actuator includes a central gear and a first driver is assembled with the central gear. In preferred embodiments, the valve has a second driver assembled with the central gear. The central gear is arranged to alternately connect with the first or second driver.

The first member and the second member may be interrelated in a number of ways. For example, the first member and second member may be threadably engaged with one another. The first member may comprise a hollow internally threaded cylinder. In other embodiments, the drivers and valve member are connected using other means, including electrical or hydraulic.

Another aspect of the present invention is a valve control system arranged for controlling the operation of a valve. The control system comprises at least one sensor for sensing a condition. A controller is arranged to actively control the operation of the valve during a predetermined cycle, according to a predetermined profile. The profile determines a desired condition during the cycle. The control system includes a driver arranged with the controller for driving the position of the valve. The valve position is adjusted during the cycle to conform the sensed condition to the desired condition.

The at least one sensor desirably comprises a sensor arranged for sensing the condition and the condition may be selected from the following: the pressure at an inlet of the valve and the position of the valve. Other conditions may be sensed and used by the control system. The controller may comprise a computer arranged to receive data from the at least one sensor concerning the condition. The controller includes a memory storage device in which the profile is stored. The controller further includes a processor arranged to compare the sensed condition to the desired condition. The processor is also desirably arranged to determine an adjustment to the position of the valve based upon the profile.

The controller desirably communicates with the driver so as to move a valve member of the valve to a position determined by the profile. In certain embodiments, the profile determines at least one desired condition for achieving a desired reduction in the speed of a moving craft.

In certain preferred embodiments, the sensed condition comprises a first sensed condition. The controller is arranged to accept the first sensed condition from the at least one sensor and communicate with the driver so as to adjust the position of the valve. The controller accepts a second sensed condition from the at least one sensor and readjusts the position of the valve. In preferred embodiments, conditions are repeatedly sensed and utilized to adjust and readjust the position of the valve according to the profile.

The desired condition may comprise a first desired condition determined by the profile for a first point in time during the cycle. The profile may determine a second desired condition for a second point in time during the cycle.

The driver may comprise a first driver and the system may comprise a second driver. The first driver and the second driver are alternately connected with the valve and controlled by the controller.

In certain preferred embodiments, the controller comprises a first controller and the system includes a first monitor for receiving data from the at least one sensor. The first driver, first monitor and first controller desirably comprise a first channel. A second controller is desirably arranged with a second driver and a second monitor in a second channel. Desirably, at least one first sensor is connected to the first monitor and the first controller and at least one second sensor is connected to the second monitor and the second controller. In certain preferred embodiments, two separate channels are arranged to control the valve so that in the event that there is any failure in one of the channels, the other channel may be utilized to control and operate the valve.

In a preferred embodiment, the controller is arranged to control the valve based upon a profile comprising a model. The model takes into account one or more of the following: the craft type, craft weight, and craft speed. In a system in which the valve interacts with a hydraulic energy transfer system and craft-engaging device, damping and spring rate for the system is also taken into account. The position of the craft for a corresponding position of the valve is also preferably considered in the model. In certain embodiments, the hydraulic energy transfer system includes a ram for transferring energy from the craft-engaging device to the hydraulic fluid. Preferably, a calculation or data for the pressure within the hydraulic energy transfer system for a given position of the ram is utilized in the model.

The components preferably comprise software stored in an electronic memory storage medium but may also comprise electronic hardware wired to perform each function. There are a number of computer systems on which the valve control system may be implemented. On an aircraft carrier, the valve control system preferably interfaces with communications and computer systems that are already in place. The system is preferably a computer system having hardware and software with a data acquisition speed of at least 3,200 operations per second and the necessary ROM and ram components. The data acquisition speed is rate at which the system checks the sensors in the system and makes the necessary computations.

The controller is preferably arranged with sensors to receive data concerning the ram position and velocity, the pressure within the hydraulic energy transfer system, and optimization data. In certain preferred embodiments, the optimization data comprises data including a barricade offset and cable stretch offset. The controller is arranged to provide valve position data and commands to the valve.

In a preferred embodiment, the controller determines the desired valve position for the position of the craft. The position of the craft corresponds to the position of the ram. Preferably, the controller computes a desired valve position based upon data from sensors concerning the ram position and velocity. In certain preferred embodiments, the controller computes valve position taking into account data concerning a barricade offset, cable stretch offset, and craft weight. The controller is arranged to provide a desired valve position and commands to the valve.

Preferably, the controller is arranged for computing the valve position based upon a model for determining the position of the craft. The position of the craft may comprise a corresponding position of the ram, which is calculated utilizing data, rather than utilizing data from a sensor for determining the position of the ram.

### BRIEF DESCRIPTION OF THE DRAWINGS

These and other features, aspects and advantages of the present invention will become better understood with regard to the following description, appended claims and accompanying drawings where:

FIG. 1 is a schematic view of a prior art system for arresting an aircraft;

FIG. 2 is a schematic perspective view of a landing aircraft with respect to a prior art system for arresting an aircraft;

FIG. 3 is a schematic view of a valve in a prior art system for arresting an aircraft;

FIG. 4 is a is a schematic view of a system for decreasing the speed of a moving craft in accordance with an embodiment of the present invention;

FIG. 5 is a cross-sectional view of a first valve in the embodiment of FIG. 4;

FIG. 6 is a cross-sectional view of a second valve in the embodiment of FIGS. 4 and 5;

FIG. 7 is a schematic view of a control system in the embodiment of FIGS. 4-6;

FIG. 8 is a schematic of a control system in accordance with the embodiment of FIGS. 4-7;

FIG. 9 is a functional block diagram of the operation of a controller in accordance with the embodiment of FIGS. 4-8;

FIG. 10 is a diagram of an open loop system for a controller in accordance with the embodiment of FIGS. 4-9;

FIG. 11 is a schematic of a control system in accordance with the embodiment of FIGS. 4-10;

FIG. 12 is a diagram of the computerized operation of the control system in accordance with the embodiment of FIGS. 4-11;

FIG. 13 is a diagram of the computer operations in the control system in accordance with the embodiment of FIGS. 4-12;

FIG. 14 is a schematic of a control system for a valve in accordance with the embodiment of FIGS. 4-13;

FIG. 15 is a schematic of the operation of the controller in accordance with the embodiment of FIGS. 4-14; and

FIG. 16 is front elevational view of a valve in accordance with an embodiment of the invention;

FIG. 17A is a cross-section taken along lines A-A in FIG. 16;

FIG. 17B is a schematic view of FIG. 17A;

FIG. 18 is a rear elevational view of the valve in accordance with the embodiment of FIGS. 16-17B;

FIG. 19 is a side elevational view of the valve in accordance with the embodiment of FIGS. 16-18;

FIG. 20 is a cross-sectional view taken along lines B-B in FIG. 19;

FIG. 21 is a top-right perspective view, partially in section, of a valve in accordance with the embodiment of FIGS. 16-20;

FIG. 22 is a partial schematic cross-sectional view of the valve in accordance with the embodiment of FIGS. 16-21;

FIG. 23 is a detail of FIG. 22;

FIG. 24 is a schematic view of a control system for the valve in accordance with the embodiment of FIGS. 16-23; and

FIG. 25 is a schematic of a backup power supply for the valve in accordance with the embodiment of FIGS. 16-24.

### DETAILED DESCRIPTION

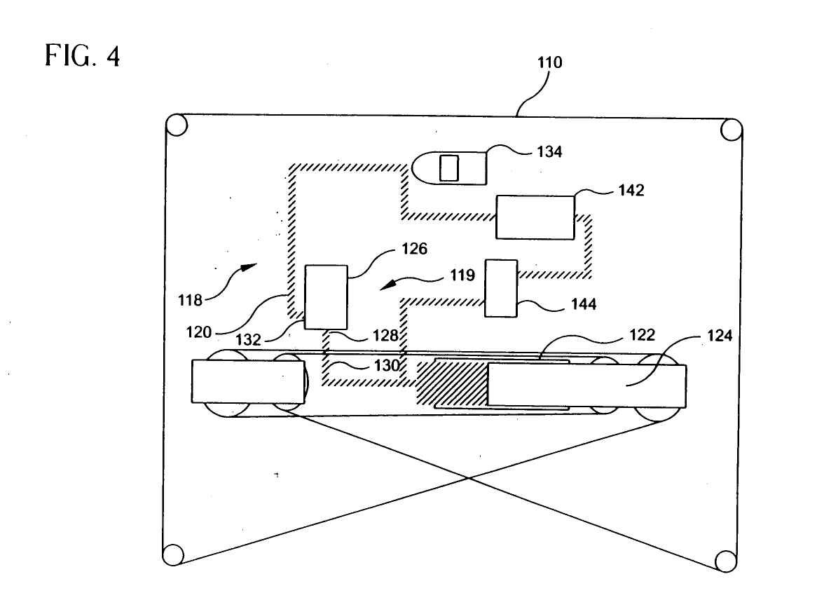

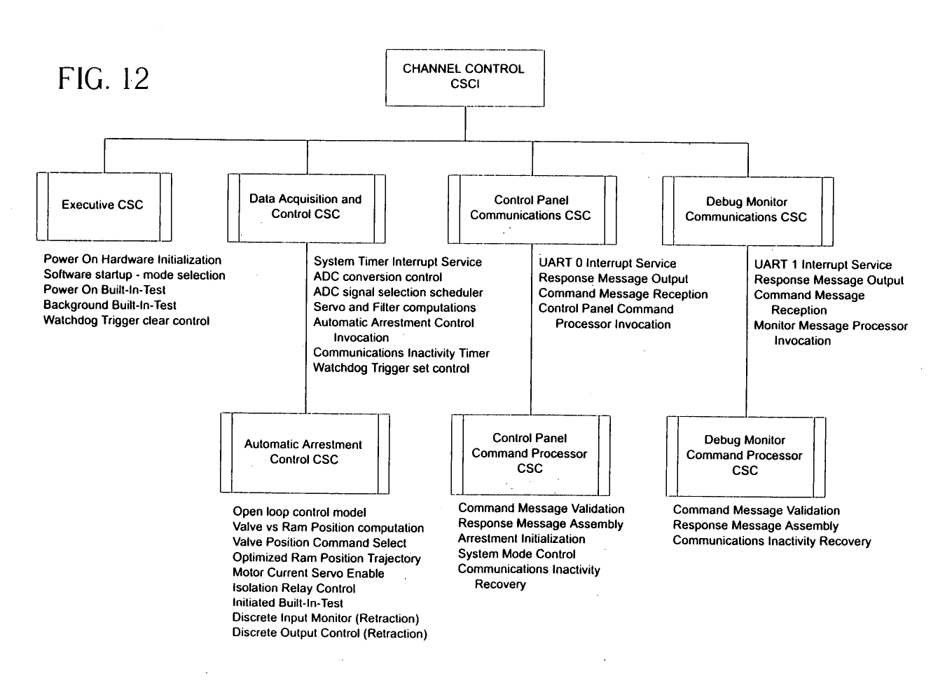

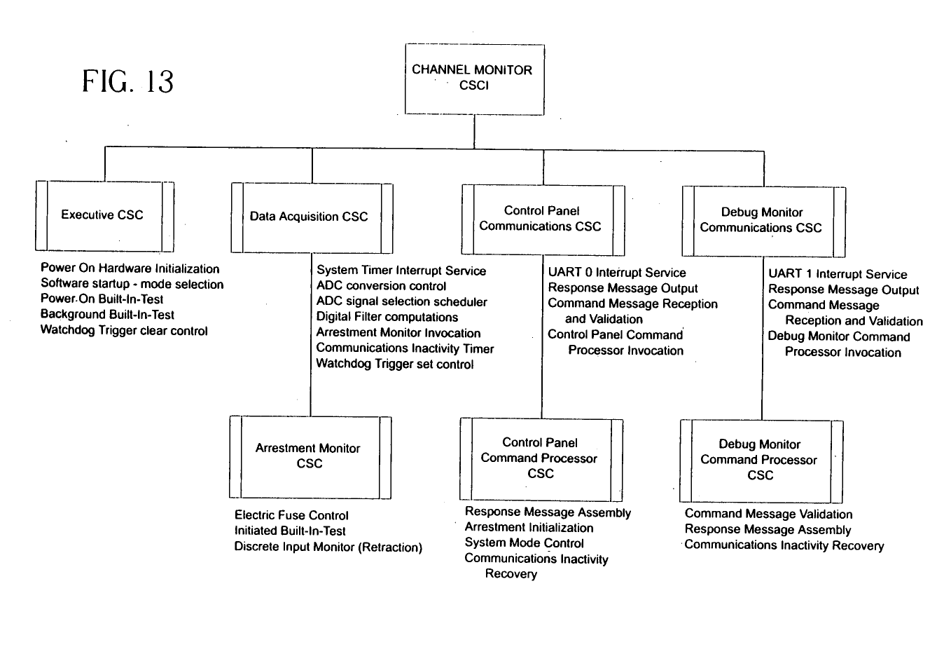

An embodiment of a system for reducing the speed of a moving craft is shown in FIGS. 4-15. As shown in FIG. 4, a pendant 110 comprising a cable is arranged with a hydraulic system 118 for transferring energy from the pendant 110 to a control mechanism 119 for controllably releasing energy from the hydraulic system 118. In the embodiment shown, the control mechanism comprises a valve 126 arranged in the hydraulic system 118. The pendant 110 applies pressure to the fluid in the hydraulic system 118 and the valve controls the flow of the fluid while the speed of the craft is being decreased.

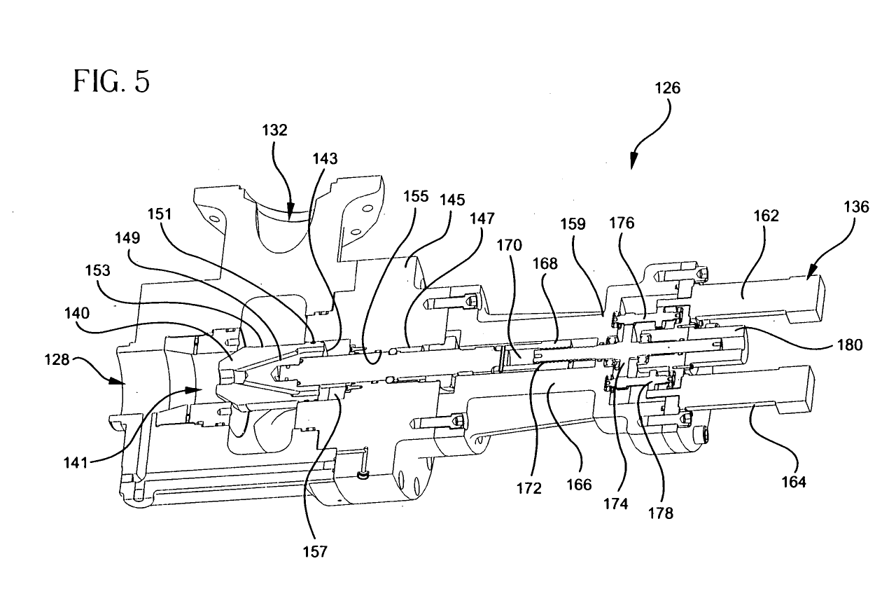

The valve 126, best seen in FIG. 5, has an inlet 128 and an outlet 132 and comprises a closure or valve member 140 for opening and closing the inlet 128 of the valve 126. When the valve 126 is open, fluid from the hydraulic system 118 is allowed to pass from the inlet 128 to the outlet 132 of the valve 126. The valve 126 includes a housing 145 connected to the hydraulic system 118 comprising a series of conduits 120 and 130. Conduit 130 is connected to the inlet 128 and a cylinder 122 that receives a ram 124. The ram 124 is connected to the pendant 110 so that the energy from the moving craft engaging the pendant 110 is transferred to the hydraulic system 118 and to the valve 126. Conduit 120 is connected to the outlet 132 and an accumulator 134 for collecting hydraulic fluid. However, the hydraulic system 118 may have other arrangements and the valve 126 may be connected to other systems in further embodiments of the invention.

The valve has a housing 145 with an inner surface 155 defining a shaft 147. The valve 126 has a valve member 140 that is mounted in the shaft 147 so as to be movable between an open position and a closed position. As shown in FIG. 5, the valve member 140 has a first side 141 facing the inlet 128 and a second side 143 opposite the first side 141. The housing 145 defines a chamber 157 adjacent the second side 143 of the valve member 140.

In a preferred embodiment, and as shown in FIG. 5, the valve member 140 has passages 149 that communicate from the first side 141 facing the inlet 128 to the second side 143 and with chamber 157. Fluid from the hydraulic system 118 is communicated from the first side 141 to the chamber 157 at the second side 143 to balance the forces on the valve member 140. Even when the valve member 140 is in the closed position. Thus, the valve member 140 is balanced, as the fluid pressure at the inlet 128 equals an opposing fluid pressure on an opposite side of the valve member 140, adjacent the second side 143. The first side 141 and second side 143 are sized so as to minimize the forces required to move the valve member 140. This feature allows the valve member 140 to be controllably opened and closed using a relatively small force needed to overcome the friction between the valve member 140 and surrounding structure to move the valve member 140. The load applied to the valve member by the hydraulic system is thereby reduced.

The valve member 140 has at least one third side 153 adjacent the first side 141 and facing the outlet 132. In the embodiment shown, the valve member 140 has a generally conical shape. However, in other embodiments, the valve member may have a different shape. In preferred embodiments, the valve member 140 has a tapered first side 141 so that, as the valve member 140 is moved with respect to the inlet 128, the size of the opening that allows fluid to pass varies. Varying the size of the opening at the inlet 128 varies the fluid pressure at the inlet 128. However, in other embodiments, the valve member 140 may have other shapes and may or may not operate to vary the opening at the inlet 128.

The valve member 140 is arranged in the shaft 147 so that the third side 153 engages the inner surface 155 of the housing 145 that defines the shaft 147. A seal 151 is located between the inner surface 155 and the third side 153 of the valve member 140, to seal the chamber 157. The friction developed between the seal 151 and the inner surface 155 must be overcome in moving the valve member 140. Other seals are provided, where appropriate.

In certain preferred embodiments, the valve member 140 is mechanically connected to a driving apparatus 136. In preferred embodiments, the driving apparatus 136 is connected to the valve member 140 through an actuator 159. More than one driving apparatus 136 is desirably arranged with and connectible to the valve member 140. The driving apparatus 136 preferably comprises a first motor 162 and a second motor 164 that are alternately connected to the valve member to move the valve member to a desired position. Thus, if the first motor 162 fails for any reason, the second motor 164 is activated. Preferably, the motor controlling the valve member 140 may be switched during an operation in which a craft is being decreased in speed or arrested. Switching between alternate motors is accomplished by hardware, software, or both. A computerized controller may be used to detect a problem with one motor and switch to the other motor. Each of the motors may be arranged to run in an idle mode until activated for moving the valve member 140. In one example, the drivers comprise two electric DC motors.

In certain embodiments, the actuator 159 includes a linkage 166 connected to the valve member 140. The linkage 166 may comprise a cylinder 168 having a bore 170, which is internally threaded. The actuator 159 includes a central gear 174 that has a shaft 172 received in the cylinder 168. The shaft 172 of the central gear 174 is externally threaded so that when the central gear 174 rotates, the cylinder 168 moves linearly to move the valve member 140 between positions. An external surface of the cylinder 168 is shaped so as to allow linear movement of the cylinder 168 while securing the cylinder against rotation. For example, the external surface of the cylinder and the inner surface 155 of the shaft 147 may have a hexagonal shape.

The actuator 159 may also comprise a first gear 176 for connecting the first motor 162 to the central gear 174 and a second gear 178 for connecting the second motor 164 to the central gear 174. The first gear 176 and second gear 178 are arranged so that the first motor 162 and second motor 164 are assembled with the central gear 174 and are alternately connected to the central gear 174. The gears and motors are arranged so that either the first motor 162 or second motor 164 drive movement of the valve member 140. Both motors do not drive movement of the valve member at the same time, although the inactive driver may run in idle mode while the active driver moves the valve member. For example, the first gear 176 may be in engagement with the central gear 174 while the second gear 178 is out of engagement with the central gear 174 and the second motor 164 runs idle. The first gear 176 may be moved out of engagement with the central gear 174 and the second gear 178 may be moved into engagement with the central gear 174 to switch motors.

In preferred embodiments, the valve also has at least one sensor 180 for detecting movement of the valve member 140. In a preferred embodiment, the sensor 180 detects rotary movement of the central gear. For example, the sensor 180 may comprise a multi-turn resolver. Other sensors may be used. The sensor may detect the movement of the valve member directly or indirectly. In other embodiments, the sensor detects the linear movement of the linkage to determine the position of the valve member 140.

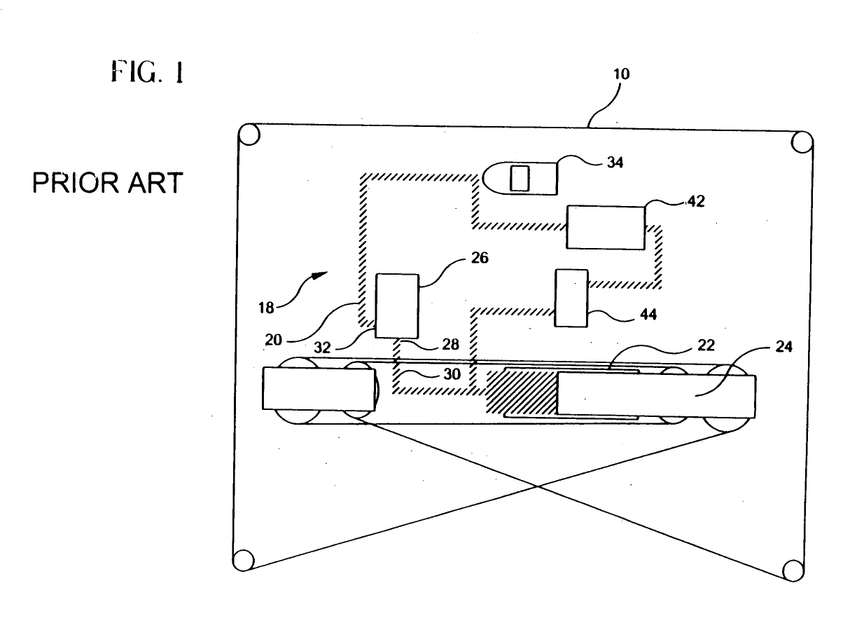

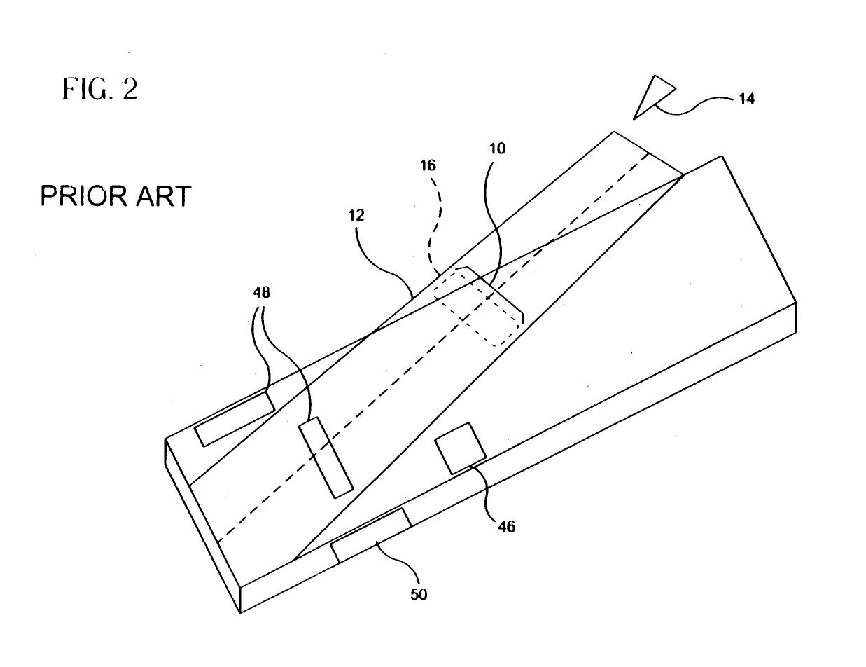

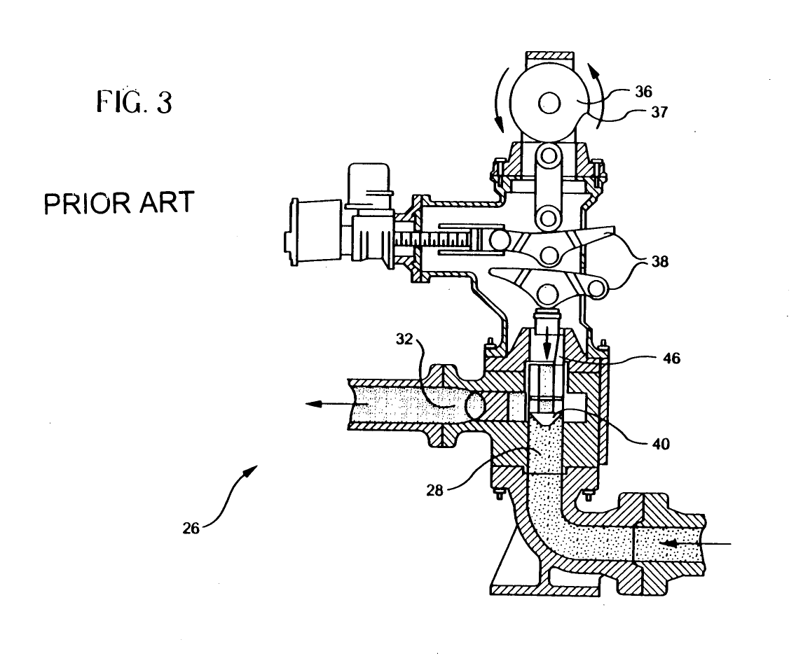

In the prior art system discussed in connection with FIGS. 1-3, the fluid pressures acting on the poppet 40 forced open the poppet 40 and the mechanisms within the valve 26 were utilized to slam the poppet 40 shut through application of brut force. Thus, to move the poppet 40, a force to oppose the 10,000 lbs. per square inch of pressure at the inlet 28 was required. In embodiments according to the present invention, the fluid pressures on the valve member 140 for the valve 126 are balanced. In the embodiment shown, the system produces about 80,000 pounds of force at the inlet 128. Accordingly, the load required to move the closure 140 is reduced from the load based on 80,000 pounds of force to between about 2,000 and 3,000 pounds force, which is required to overcome friction in seal 151 and sliding members. The mechanical, motor driven actuator connected to the valve member for moving the closure becomes feasible because of the reduced load required to move the valve member 140. Furthermore, it also becomes feasible to control movement of the closure during an arresting cycle. The mechanically actuated valve has a valve member that is adjustable during an arrestment cycle and may be moved to any position between the closed and open positions, so as to optimize the arrestment of the craft.

During operation, the moving craft engages the pendant 110 and energy is transferred from the moving craft to the hydraulic system 118. The hydraulic system 118 transfers energy to the valve 126. The valve member 140 is controllably moved to positions between opened and closed positions while the speed of the craft is being decreased, according to a desired speed reduction profile. Thus, the valve member 140 may be moved between a fully open and a fully closed position and may be moved in either direction to positions between those positions. Preferred embodiments include sensors for sensing conditions within the arresting system and adjusting the position of the valve member 140 to achieve the desired the speed reduction.

In preferred embodiments, conditions are monitored during the arresting cycle. The conditions monitored include the inlet pressure, the ram position, and/or the position of the valve member. For example, sensors for sensing the pressure within the cylinder 122 or at the inlet 128, or both, as well as sensors for sensing the position of the ram and the position of the valve member may be used. The sensed condition is compared to a desired condition that is determined by the profile. The profile, in certain preferred embodiments, achieves a desired reduction in speed within a predetermined stopping distance.

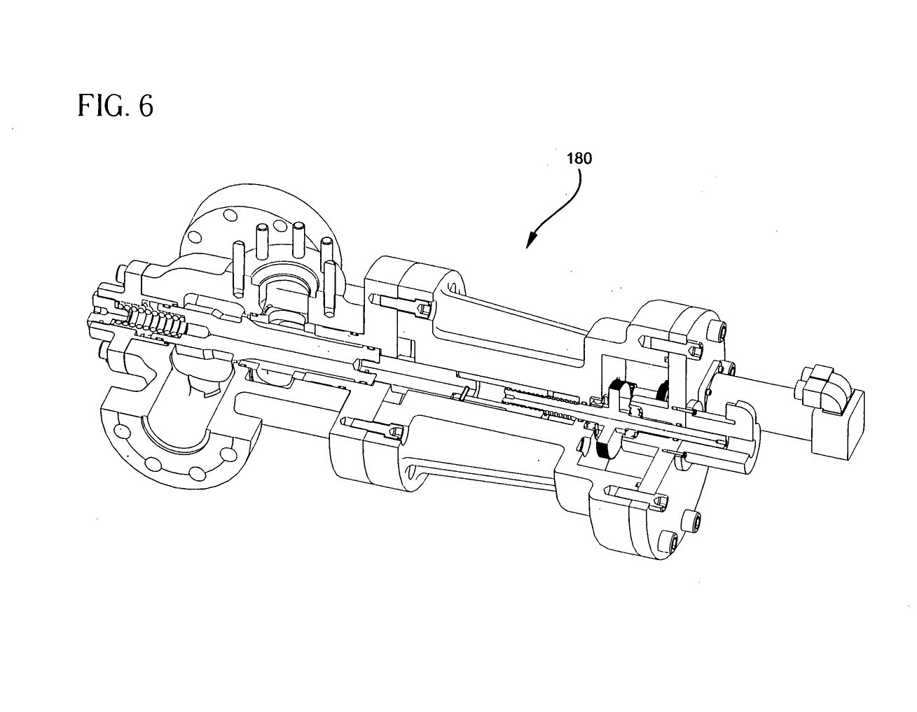

After the speed of the craft is sufficiently reduced, the valve member 140 is shut, arresting the craft. The pendant 110 is returned to its starting position to receive another craft, using a retraction valve 144, such as the valve shown in FIG. 6. The retraction valve 144 has a motor-driven linkage for moving the valve member between open and closed positions and for connecting the inlet and outlet of the valve. When the inlet and outlet are connected, the fluid is used to return the pendant 110 to its starting position.

The system for reducing the speed of a moving craft includes embodiments directed to arresting a landing aircraft on an aircraft carrier, as well as any vehicle or craft.

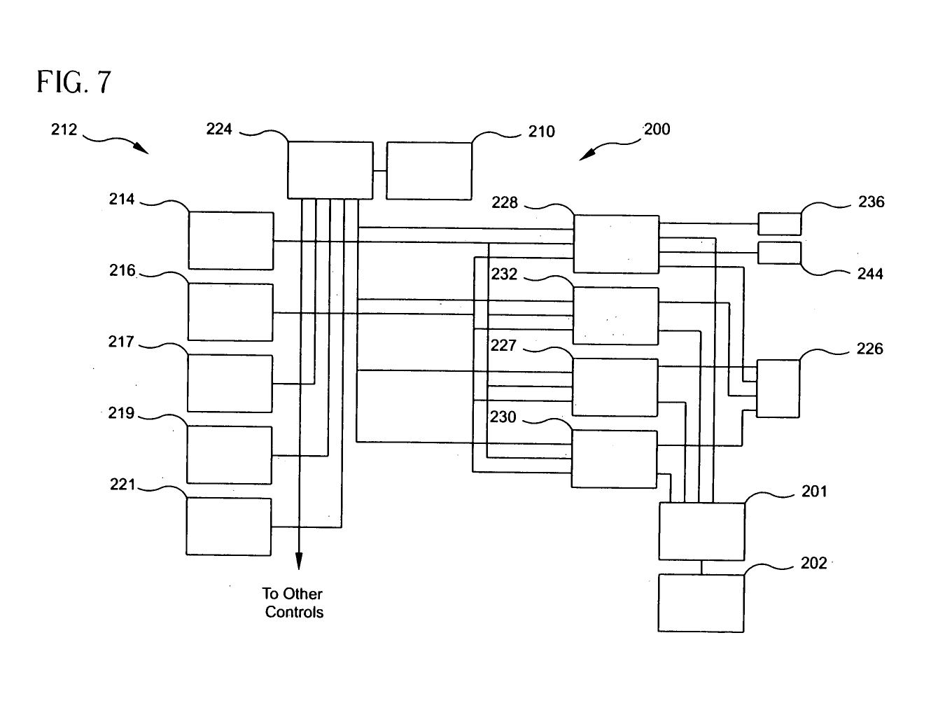

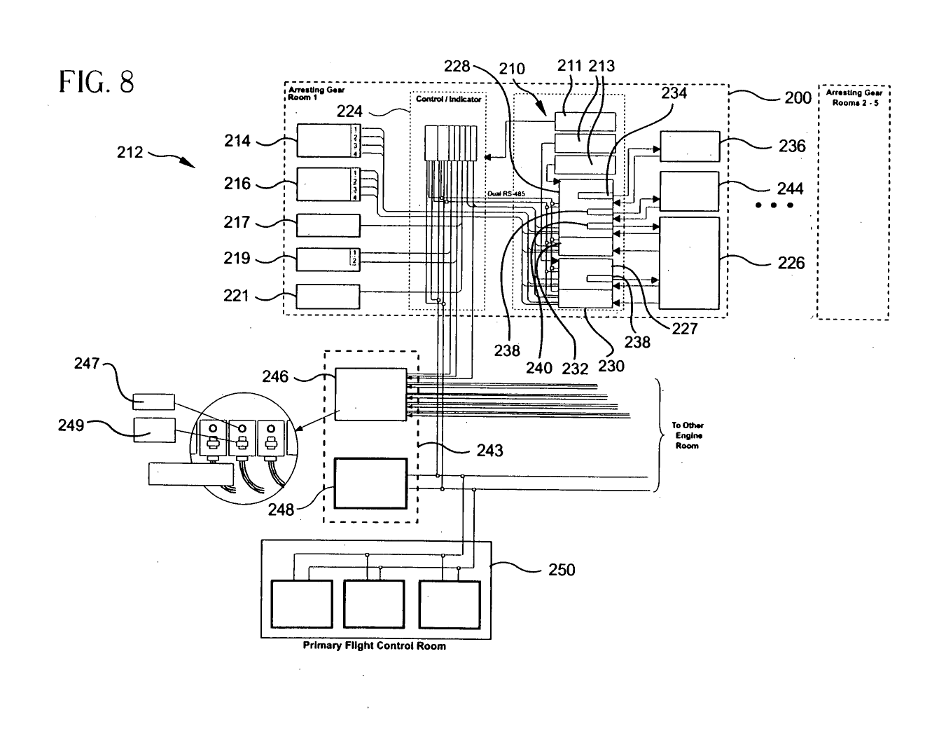

Certain preferred embodiments include a control system 200 for controlling one or more valves as shown in FIGS. 7-13. The system 200 includes a programmable digital electronic controller. In certain embodiments, the control system 20 controls a mechanically actuated valve, such as the valve shown in FIG. 5. In an embodiment for controlling a valve in arresting an aircraft on an aircraft carrier, the control system 200 desirably interfaces with the existing primary flight controller 250, deck edge controls 244, and the emergency ship power. (See FIG. 8.)

For example, the system 200 controls the operation of the arrestment valve 126 and the retraction valve 144. The control system 200 includes an uninterruptible power source (“UPS”) 210, including a UPS with an AC output 211 and a UPS with a DC output 213. The control system 200 includes internal power supplies, appropriate input/output components, housing and mountings, cables, electronic controller components, electronic monitor components, and a plurality of sensors 212.

In embodiments of the invention, the particulars of the components can be varied to apply to the particular application. As best shown in FIGS. 7 and 8, a preferred embodiment of the control system 200 has: four ram position sensors 214 on or near the ram 124; four pressure sensors 216 for sensing the pressure in the cylinder 122; a temperature sensor 217 in the conduit of the hydraulic system 118; two sensors 219 for the pressure of the fluid located in the accumulator; and a sensor 221 for the temperature of the fluid in the accumulator. These sensors are connected to an indicator 224 comprising an electronic component.

The controller 200 comprises a computer having a processor 201 and memory storage device 202 for making the necessary calculations for controlling the arrestment valve 226, retraction valve 244, and air valve 236.

The indicator communicates with an arrestment valve controller 227, a retraction valve controller 228, an arrestment valve monitor 230, and a retraction valve monitor 232. The indicator 224 is also connected to the UPS 210, which has an uninterruptible AC power supply and two uninterruptible DC power supplies, as best seen in FIG. 8. The temperature sensor 217, accumulator pressure sensor 219, and accumulator temperature sensor 221 are connected to the indicator 224. The arrestment valve controller 227, retraction valve controller 228, arrestment valve monitor 230, and retraction valve monitor 232 receive data from the ram position sensors 214 and pressure sensors 216 directly. The control system 200 is located in the arresting gear room below the deck of the aircraft carrier.

The indicator 224 is programmed to automatically run a test of the equipment on power-up. The test of the equipment includes a test of the sensor input values, communication line failures, failures of the erasable programmable read-only memory, and input/output channel failures. As best seen in FIG. 8, the indicator 224 is connected to the controls at the deck edge control station 244, which includes a retraction control and indicator panel 246 and a deck edge display panel 248. The indicator panel typically comprises a plurality of five NEMA 4X boxes on a common support bracket and includes a fully retracted indicator light 247 and a spring returned retraction valve control lever 249. The indicator 224 is also connected with the primary flight control room controls 250, which include an air boss display panel 251, a primary flight control display panel 253 and an arresting gear engine electronics enclosure 255.

As best seen in FIGS. 7 and 8, a controller and a monitor is associated with each of the retraction valve 244 and arrestment valve 226. The retraction valve controller 228 has a solenoid drive 234 for an air valve 236 used in the retraction of the cable, a first motor drive 238 connected to the driver for the retraction valve 244 and a second motor drive 240 connected to the arrestment valve 226. The retraction valve 244 has electronic components to communicate with the retraction valve controller 228 and the arrestment valve 226 has electronic components to communicate with the arrestment valve controller 227, with the arrestment valve monitor 230 and retraction valve monitor 232. The arrestment valve controller 227 has a motor drive 242 connected to the driver for the arrestment valve 226. The monitor receives the same sensor data as the controller and monitors all the operations of the controller. Preferably, the monitor tests the valve prior to a speed-reduction operation. In preferred embodiments, the arrestment monitor also tests the other components in the system, such as the sensors for monitoring drivers. For example, the arrestment monitor may test the operation of the valve by moving the valve from a fully open position to a fully closed position. Two drivers may be arranged for alternately driving the operation of the valve. Testing the operation of the drivers may comprise running one driver against the other. The valve controller and monitor do not have direct communication between each of these components. The valve controller and monitor independently report data to the control panel and respond to control panel commands.

A control system similar to system 200 is desirably provided for each cable on the aircraft carrier and the control system for each of the cables communicates with the deck edge controls 247 and the primary flight controls 250. Desirably, the control system 200 interfaces with the existing arresting gear crosscheck system. Desirably, operator work stations are associated with one or more of the controllers. An operator work station is associated with the indicator 224. A separate indicator panel is provided at the deck edge controls station at the flight deck, including an operator station for the retraction valve.

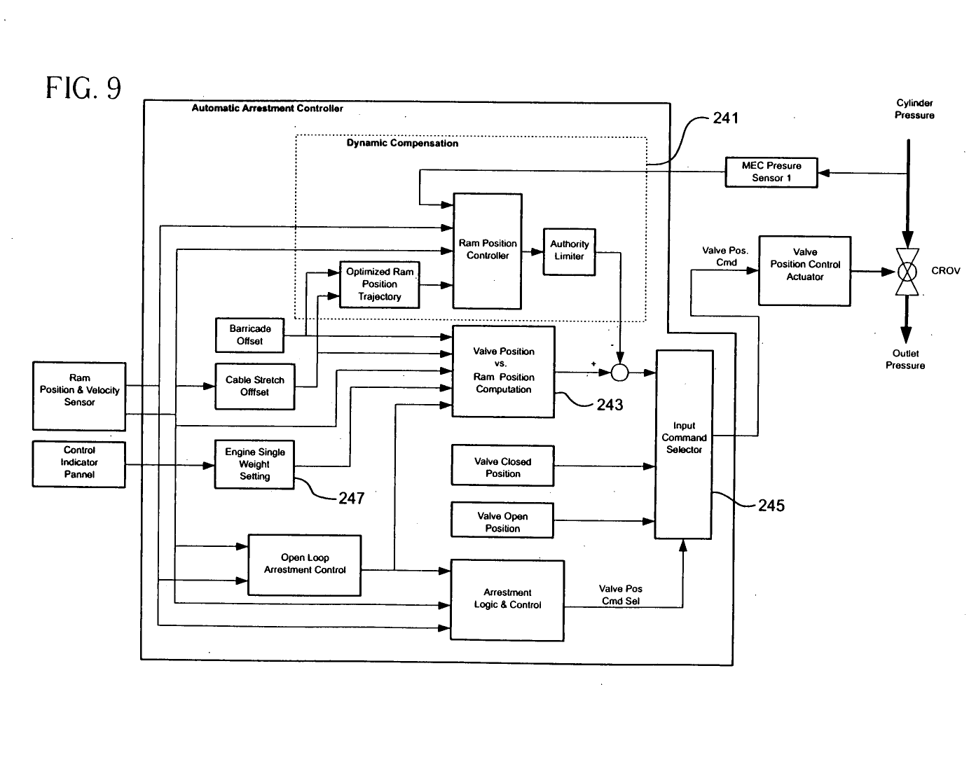

A functional block diagram for the arrestment valve controller 227 is shown in FIG. 9. The controller 227 is programmable so that certain parameters may be changed. In certain preferred embodiments, the controller generally follows the block diagram shown. The controller is desirably programmed with a closed loop control system for modulating a condition of the craft speed-reducing system to maximize the available stopping distance using the maximum available cable length and therefore minimizing the forces on the aircraft structure. In a preferred embodiment, the closed loop program receives the ram velocity and ram position and determines a desired ram position using the profile. The desired ram position is determined independently of the initial ram position, aircraft velocity, or aircraft weight. For example, the desired ram position is determined at 241 in FIG. 9. The program performs a real time parameter computation and determines an adjustment to the valve. For example, the computation performed is represented at 243 in FIG. 9. The progress of decreasing the speed of the craft is repeatedly evaluated according to the profile. The profile determines the desired position of the craft at a given point in time during which the speed of the craft is being decreased. Thus, when a craft engages the craft-engaging device, the speed reduction operation begins. As the speed reduction operation proceeds, the craft has a desired position for a given point in time since the operation began. The speed reduction system may be arranged for arresting the craft within a predetermined stopping distance and the profile may determine the desired position of the craft at a given point in time during such arrestment. In certain embodiments, the position of the craft is compared to a desired position of the craft based on the profile and an adjustment in the operation of the control mechanism is determined. The adjustment is communicated to the valve actuator at 245, in FIG. 9.

In one preferred embodiment, the profile is based on the pressure of the hydraulic fluid within the energy transfer system. The pressure in the energy transfer system is compared to a desired pressure at a given point in time, or a maximum allowable pressure for a given point in time, while the speed of the craft is being decreased. The profile based upon pressure is desirable from the point of view of monitoring wear and tear on the system and for monitoring the force applied to the craft. The pressure in the energy transfer system may be determined directly, as by a pressure sensor, or may be calculated based upon the position of the valve closure.

The profile desirably comprises a desired rate in reduction of the speed of the craft, taking into account safety and preservation of the craft and other equipment. The profile may comprise, for example, an array of data stored in a memory storage device for interaction with a processor for monitoring and controlling the reduction in speed of the craft. In other embodiments, the system is arranged to receive data and settings from personnel, who may consult a profile in the form of a written curve or table of data. Profiles may take into account data for specific types of craft or specific conditions, such as the type of craft, weight of craft, or aircraft, wind speed, landing speed, etc. The profiles are provided based upon considerations such as safety and are developed empirically. They may be provided by the owners of the system. In preferred embodiments, the system is arranged to refer to the profiles which are stored in a separate file on a memory storage device for a computer system used in controlling the reduction in speed of the craft. The profile may be separately maintained or revised by users of the system. The profile may take a number of forms. Preferably, prior to an operation for decreasing the speed of the craft, a check is performed to confirm that the correct profile is being used.

The arrestment valve is driven to a position determined by the profile so that the result is a commanded position for the ram. Data are continually received from the sensors and adjustments in valve position are continually made to accurately control the arrestment valve to achieve the desired ram position. The ram position is representative of the position of the aircraft engaging the cable. The only critical parameter to be received by the controller regarding the particular arrestment cycle is the aircraft weight. The controller is programmed to use the aircraft weight information provided for each arrestment cycle to optimize control of the arrestment valve by selecting a profile comprising an optimum set of compensation parameters.

The profile comprises mathematical expressions or lookup tables stored in memory. The equations or lookup tables can be easily modified or updated, as the profile is implemented as data or software algorithms stored in the processor memory.

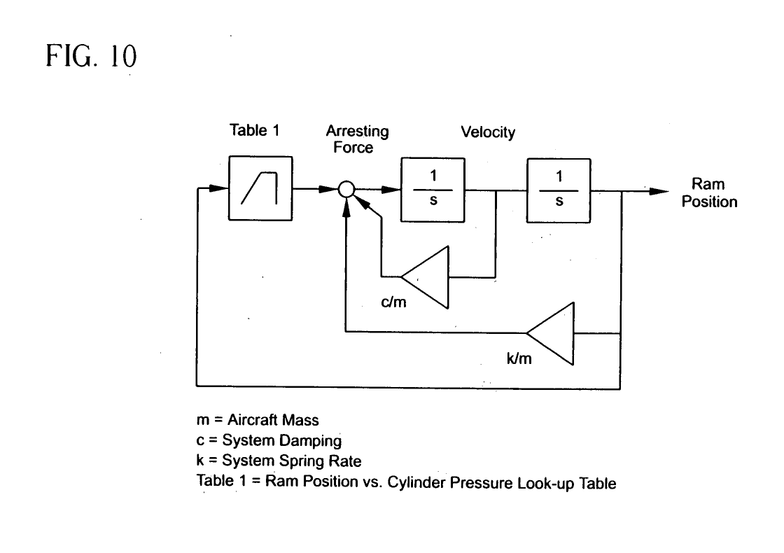

In other embodiments, the operation to decrease the speed of the craft is not directly monitored. The position of the craft is determined based upon a computational model and the operation of the control mechanism is determined based upon the model. In the event that there is a failure in feedback of the ram position, the controller is also programmed for an open loop arrestment program represented at 247 in FIG. 9. The open loop program is preferably only activated when there is a loss of the ram position data from the ram position sensors, or other sensors. The open loop program is based upon a time-based ram position generator that uses a simplified model of the aircraft and arrestment cable system. The model is illustrated as shown in FIG. 10. The model generates a ram position reference with respect to time so that the arrestment valve may be controlled in the absence of data from the ram position sensor. The profile may comprise, or the controller may be programmed based upon, an algorithm for calculating the position of the aircraft with respect to time during an arrestment cycle. The aircraft weight, cable force, and aircraft speed may be used to calculate the position of the aircraft. The cable force may be calculated based upon the spring rate of the cable, the deck width (and width of the cable), and aircraft position. The position and velocity of the ram may be calculated based on the tension of the cable, and the pressure of the hydraulic fluid. The pressure of fluid in the cylinder 122 may be calculated based upon the initial pressure, and the flow of the fluid. The flow of the fluid may be calculated based upon the cylinder 122 pressure, and the pressure in the accumulator 134. The calculations should take into account that the cable stretches under the loads involved. Each aircraft has a different speed and weight, which determines the pressure profile needed to stop the aircraft in the required distance.

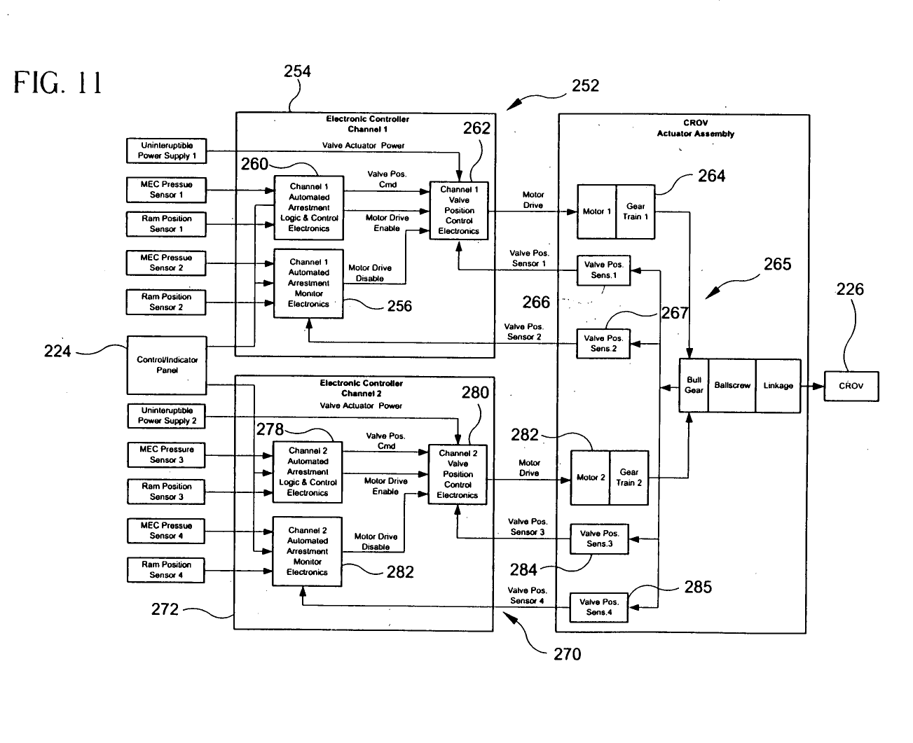

The arrestment valve controller 227, in certain preferred embodiments, comprises a first channel and a separate second channel, as shown in FIG. 11. The first channel 252 of the arrestment valve controller 227 has a first controller 254, a first monitor 256, and a first set of sensors 258. The first set of sensors 258 comprise two pressure sensors and two ram position sensors, arranged so that the first controller 254 receives data from one pressure sensor and one ram position sensor and the first monitor 256 receives data from the other pressure sensor and the other ram position sensor, as shown. The first controller 254 desirably has automated arrestment electronics 260 and valve position electronics 262. The automated arrestment electronics 260 receives data from the pressure sensor and ram position sensor and also communicates with the indicator 224. The automated arrestment electronics communicate with the valve position electronics in controlling the operation of the arrestment valve 226. For example, the automated arrestment electronics 260 sends to the valve position electronics 262 a valve position command and motor drive enable command. The valve position electronics 262 communicates with a first motor 264 that is connected to the actuator 265 for the arrestment valve 226. The valve position electronics 262 also receives data from a first valve position sensor 266. The first monitor 256 is connected with the valve position electronics 262 and with a second valve position sensor 267 for delivering a motor drive disable command to the valve position electronics 262 and for receiving data from the valve position sensor 267.

In a preferred embodiment, the arrestment valve controller 227 also includes a second channel 270. A second set of sensors 276 are associated with the second channel 270 and desirably include a third pressure sensor, third ram position sensor, fourth pressure sensor, and fourth ram position sensor. The third pressure sensor and third ram position sensor are connected to the automated arrestment electronics 278, which are connected to the valve position electronics 280. For example, the automated arrestment electronics 278 deliver a valve position command and motor drive enable command to the valve position electronics 280 so that the valve position control electronics 280 can control the second motor 282 connected to the actuator 265 for the arrestment valve 226. The monitor 282 is desirably connected to the valve position control electronics 280 for delivering a motor drive disable command. The second channel 270 also includes a third valve position sensor 284 and a fourth valve position sensor 285 that communicate with the valve position electronics 280 and monitor 282, as shown.

Any discrepancies during an arrestment cycle between any of the redundant data are detected and the channel is disabled. For example, the monitor detects discrepancies or any problem with the conditions sensed by the sensors and the valve controller switches from one channel to the other. If the control system had two independent channels so that upon detection of a failure in the control system of channel 1 automatically switches to channel 2 for controlling the arrestment valve, even during an arrestment cycle. In other embodiments, more than one channel is used.

The valve control system preferably comprises one or more of the following: an executive computer software program for initializing the hardware in the system, selecting the mode for the system and testing the operability of the components in the system, including the sensors in the arrestment system; a data acquisition and control computer software program for receiving data from sensors for determining the state of a motor for operating the valve, the valve, pressure of a cylinder, or a ram position; control panel communications computer software program for controlling and validating communications between components within the system; control panel command processor computer software program for validating command messages received by the system and sending response messages from a central control system; and a monitor computer software program for testing the operation of the valve.

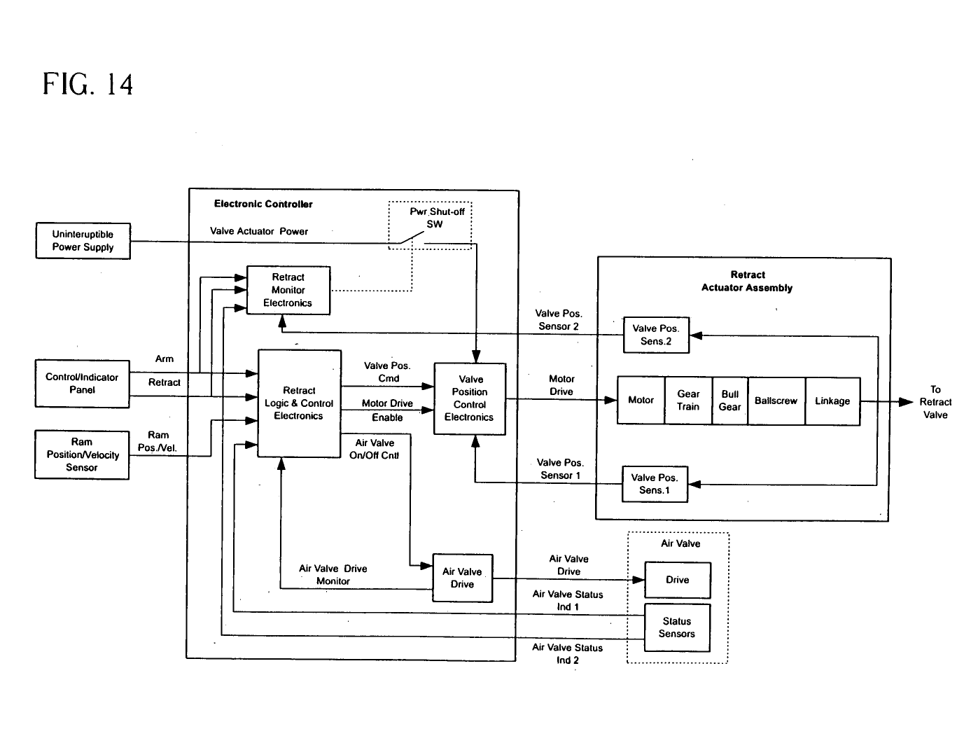

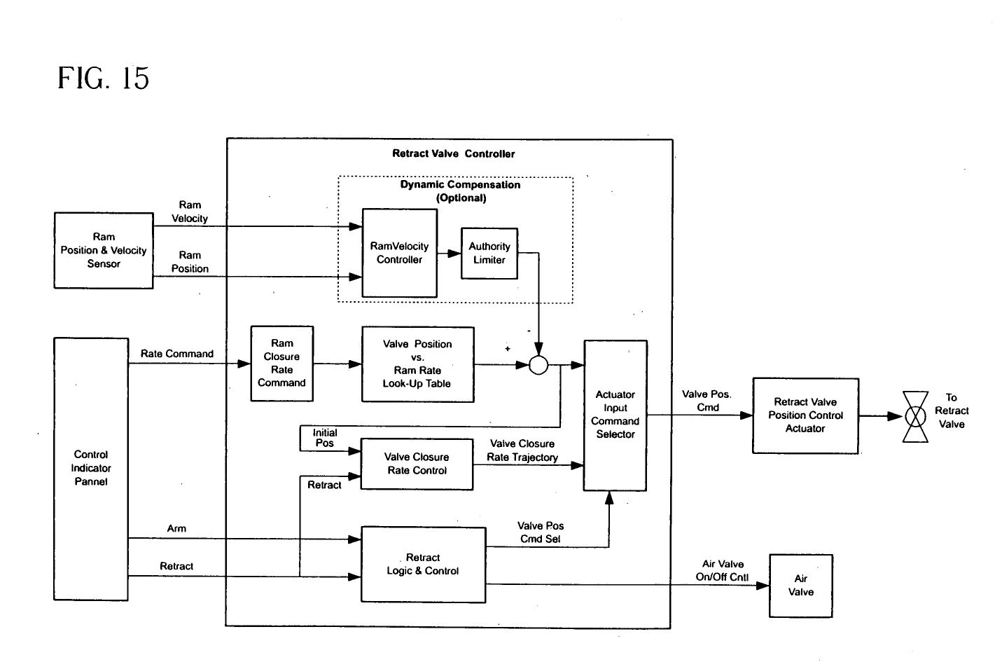

The functional block diagram for the retraction valve controller is shown in FIGS. 14 and 15.

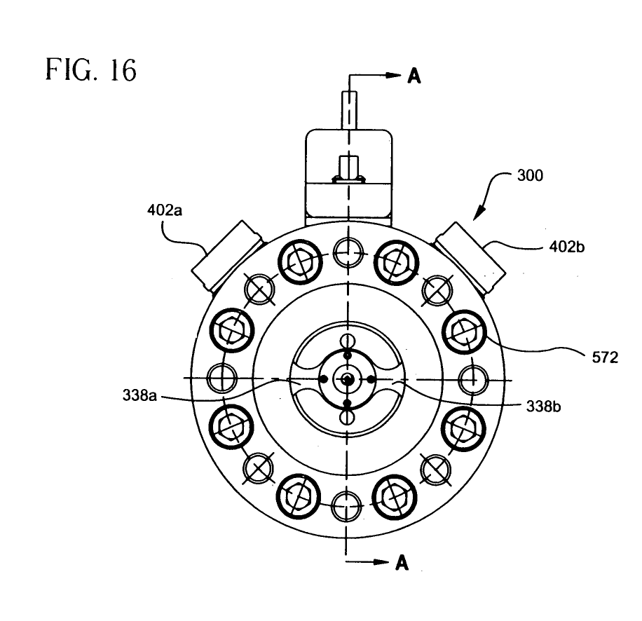

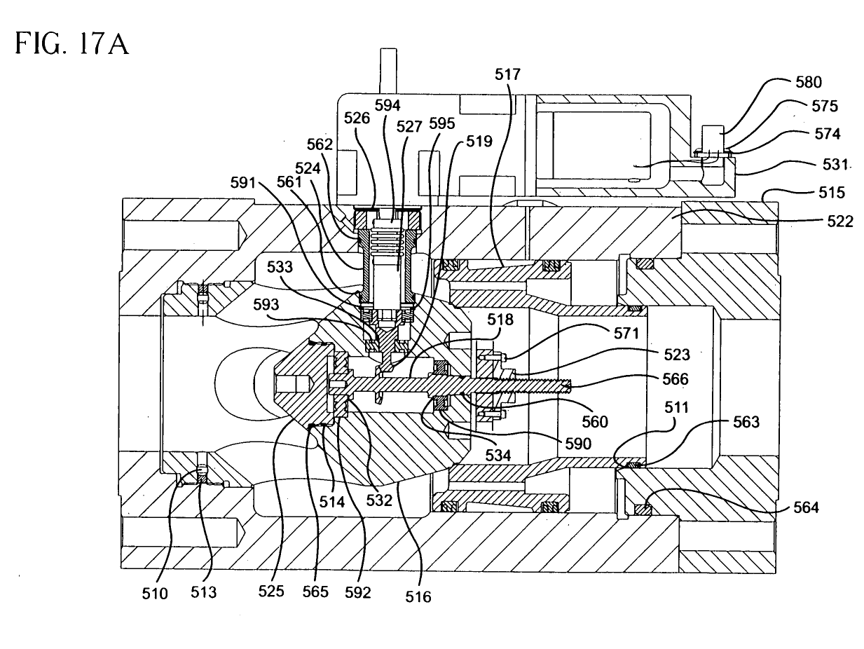

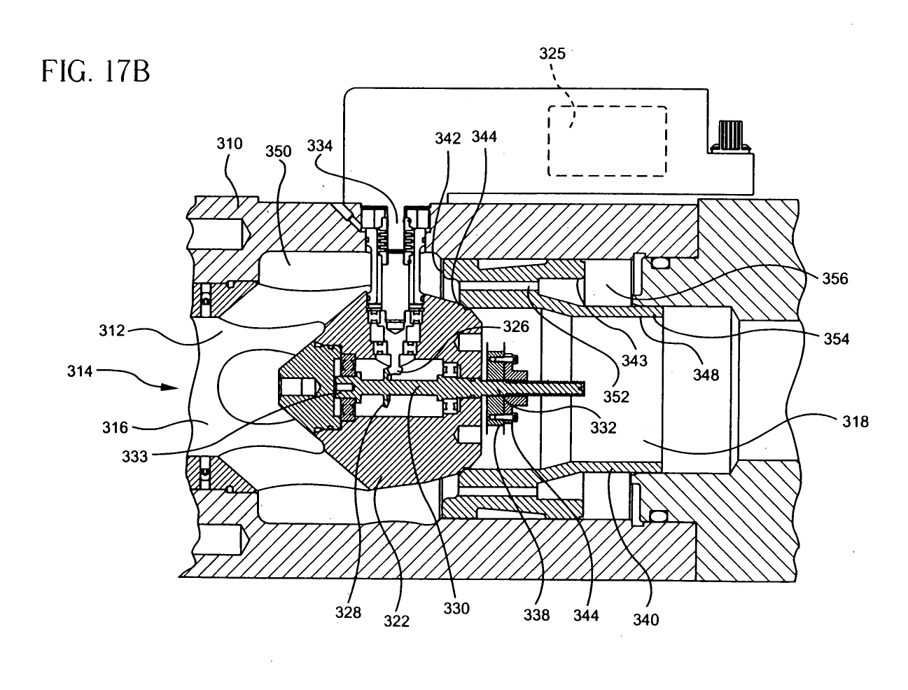

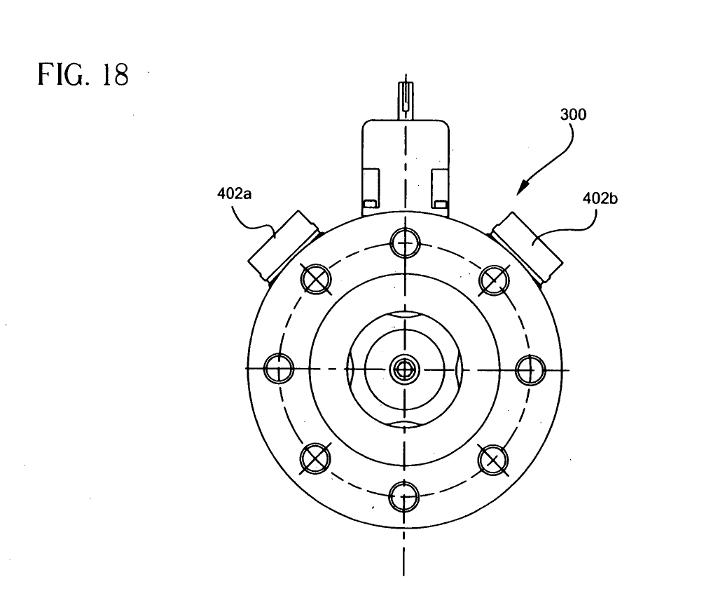

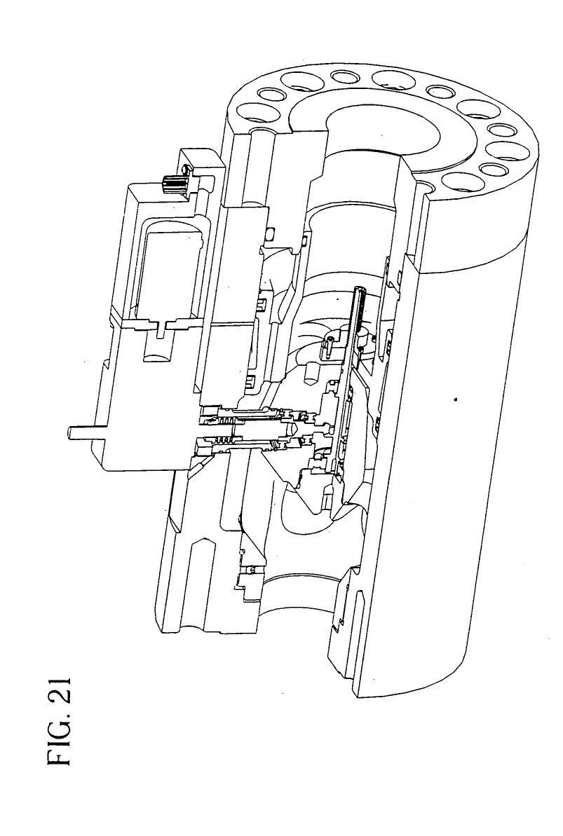

In a further embodiment of the invention, a valve in accordance with an embodiment of the invention is shown in FIGS. 16-25. As shown in the schematic view of FIG. 17B, the valve 300 has a body 310 having a passage 312 in communication with a conduit 314. The passage 312 has a first side 316 and a second side 318. The valve has a valve element 322 fixedly mounted within the passage 312, between the first side 316 and the second side 318. The valve element 322 is sized so that fluid flow through the passage 312 is not prevented by the valve element 322.

The valve has a movable piston sleeve 340 slidable in the passage 312, located between the second side 318 and the valve element 322. The movable piston sleeve 340 is generally cylindrical, with a wall 354 having a surface defining an internal passage 348. The piston sleeve 340 has a skirt 346 arranged outwardly from the wall 354 at one end of the wall 154. The skirt forms a first end surface 342 that faces the valve element 322 and a second end surface 343 that faces oppositely from the first end surface 342. The second end surface 343, wall 354 and a portion of the body 310 cooperatively define a chamber 356. The movable piston sleeve 340 defines internal passage 348 in communication with the passage 312. The piston sleeve 340 has a closed position in which a seat 344 is formed between the first end surface 342 and the valve element 322, closing off the internal passage 348 from the first side 316 of the passage 312. The skirt 346 has at least one conduit 352 that communicates between the chamber 356 and the first side 316 of the passage 312. The at least one conduit 352 is located outwardly of the seat 344 so that the conduit 352 communicates with the first side 316 of the passage 312, but is cut off from the second side 318 of the passage 312 when the first end surface 342 comes into contact with the valve element 322, forming the seat 344. Appropriate seals are located between the movable piston sleeve 340 and the body 310. An alternative arrangement for the piston sleeve may be used.

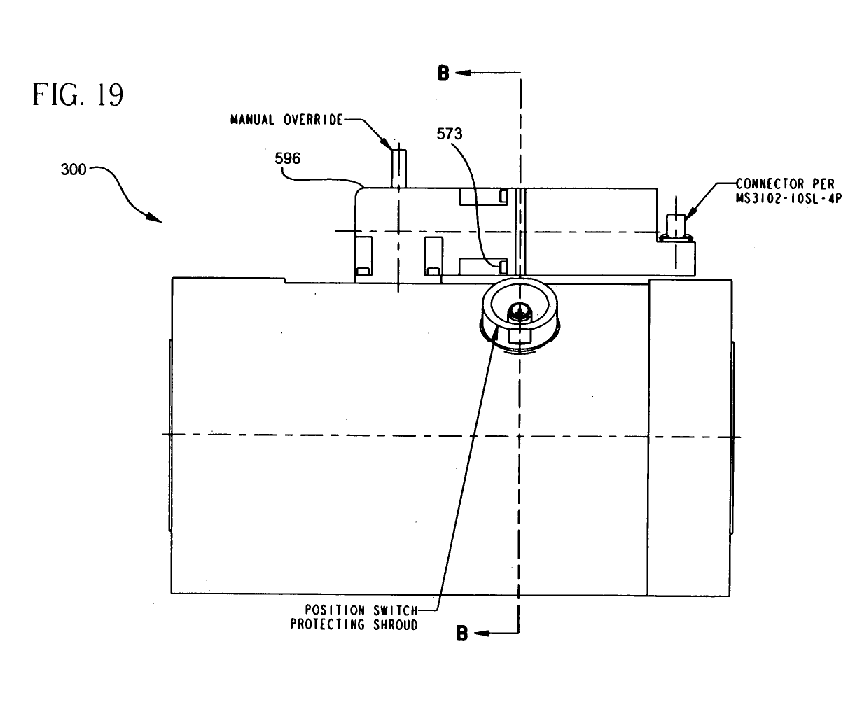

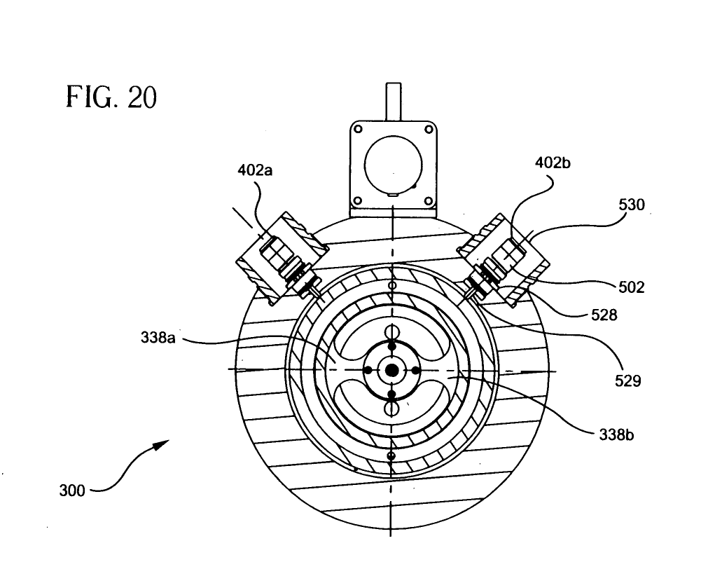

The valve is also shown in FIG. 17A, and includes several components. These components are referenced as follows: 501 is the motor adapter and sub-assembly, 502 is the switch assembly, 511 is the washer back up, 513 is the first slug-set screw locking, 514 is the second slug-set screw locking, 515 is the valve body, 516 is the valve support, 517 is the valve poppet, 518 is the gear shaft, 519 is the pinion bevel gear shaft, 522 is the valve fitting, 523 is the threaded housing on the valve, 524 is the housing pinion, 525 is the inlet bearing cone, 526 is the retainer housing, 527 is the shaft coupling, 528 is the nut jam (shown in FIG. 20), 529 is the actuator (shown in FIG. 20), 530 is the shroud (shown in FIG. 20), 531 is the cover switch, 532 is a the shim front bearing, 533 is the shim, lower pinion bearing, 534 is the shim rear bearing, 560 thru 566 are o-rings, 570 is a setscrew hex socket, 571 is a first screw, 572 is a second screw, 573 is a third screw, 574 is a washer lock, 575 is a screw panhead crossed access, 580 is a connector, or receptacle, 590 is a bearing rear bevel gear, 591 is a bearing top level pinion, 592 is a bearing front level gear, 593 is a bearing lower level pinion, 594 are coupling bellows, 595 is a ring-retainer), and 596 is the gear box (shown in FIG. 19). The piston sleeve 340 is referred to as the poppet and the valve element 322 is referred to as the support.

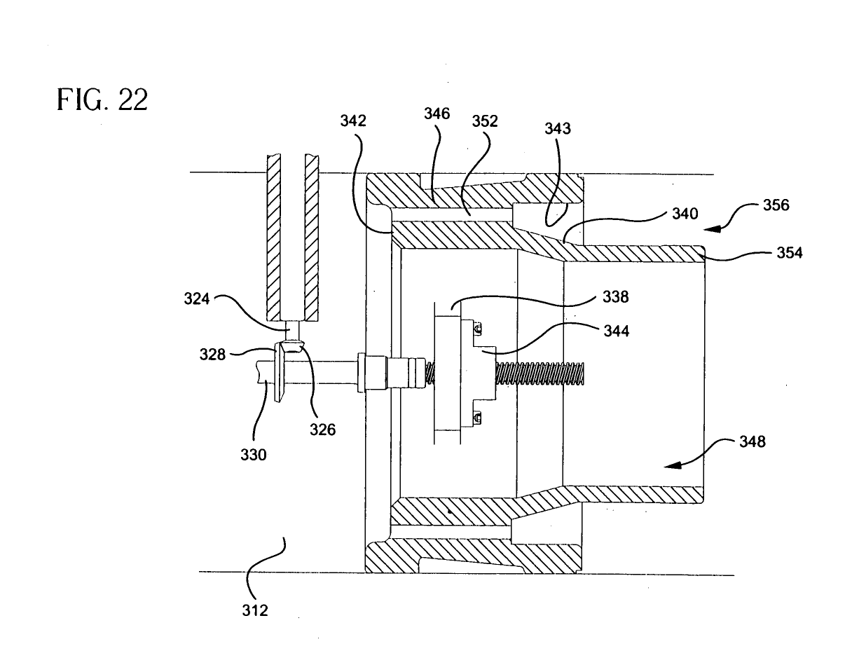

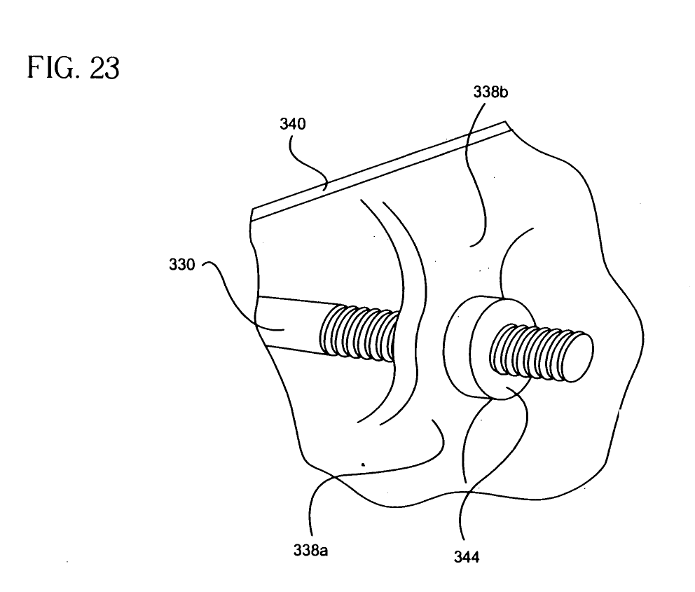

The valve preferably includes an actuator, which may comprise a gear train. A first shaft 324 is connected to a driving apparatus 325 that is mounted on an exterior side of the body. The driving apparatus 325 comprises a motor, in certain preferred embodiments. Various motors may be used, such as DC brush motors, brushless DC motors, stepper motors, or AC motors. The first shaft is received in an opening of the valve element 322 and is attached to a first bevel gear 326 so that the motor drives the first bevel gear 326. The first bevel gear interacts with a second bevel gear 328 that is integral with a second shaft, extending through the valve element 322. The second shaft 330 exits the valve element 322 at a first end 332 of the shaft 330. The first end 332 is threaded and cooperates with a threaded housing 344. The threaded housing has a threaded internal bore 336 and interacts with the threads on the second shaft 330. The threaded housing 334 is also connected to a web 338 that is integral with or attached to the movable piston sleeve 340. As seen in FIGS. 16 and 20, the web 338 may be comprised of two parts 338a and 338b. However, the web may also have other configurations. The web 338 should be configured to allow fluid to flow past the web 338. Various other arrangements may be used for the gear train, as is known in the art. As seen in FIGS. 22 and 23, the threaded housing 344 may be attached to an interior surface of the wall 354 for the piston sleeve 340. A second end 333 of the second shaft 330 is mounted in the valve element 322 by a first set of bearings. A second set of bearings is also located in the valve element 322, spaced from the first set of bearings, for supporting the second shaft 330. Bearings also support the first bevel gear 326 and the first shaft 324.

The passage 312 may be shaped so as to include a recess 350 facilitating the flow of fluid around the valve element 322. The valve has a closed position, as shown in FIG. 17B, as well as a plurality of open positions. The movable piston sleeve 340 is movable to a plurality of open pistons with respect to the valve element 322. When the movable piston sleeve 340 is in an open position, the first side 316 of the passage 312 communicates with the internal passage 348 within the movable sleeve 340 and with the second side 318 of the passage 312. To move to an open position, the motor is operated to move the piston sleeve 340 to the right in FIG. 17B. The motor is also operable in the opposite direction to move the piston back towards the closed position. In other embodiments, the piston sleeve may move in different directions and the valve element and piston sleeve may have different arrangements with respect to one another. For example, the valve element may move within the passage. In other embodiments, a portion of the body 310 may form a stationary member within the passage and the movable member may comprise a sleeve-shaped member or other valve element.

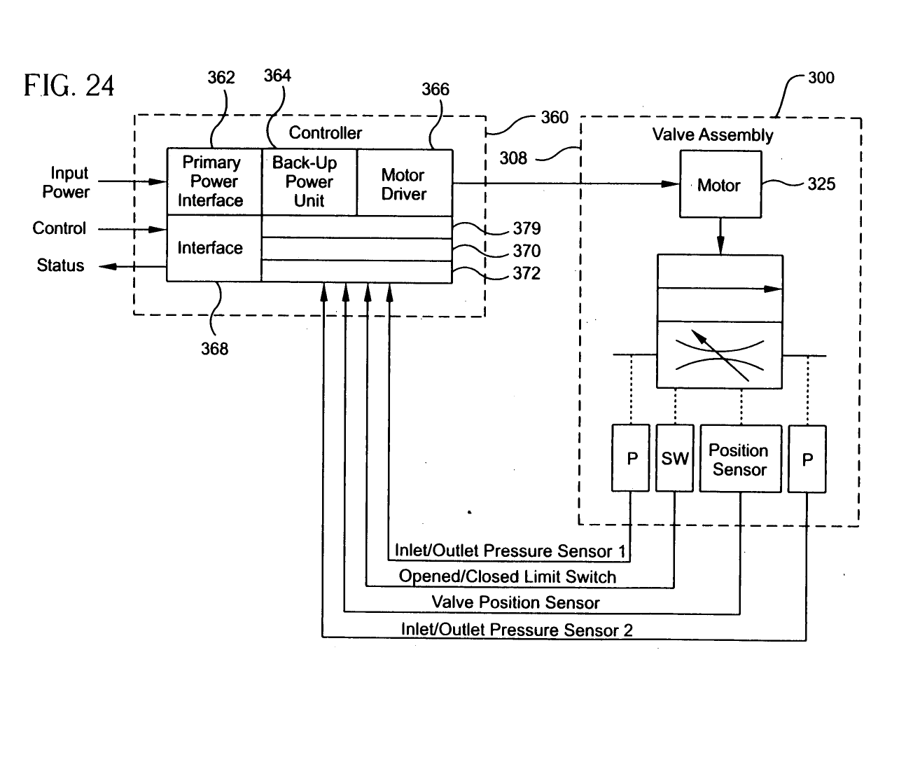

In preferred embodiments, the valve includes a monitoring and/or control system, as shown schematically in FIG. 24. The monitoring system comprises at least one sensor for determining a condition of the valve. In a preferred embodiment, pressure sensors are located at the first side 316 and the second side 318 of the passage 312. A position sensor 402 also senses the position of the movable piston sleeve 340. The position sensor may comprise a first sensor for determining an open position of the sleeve 402a for determining an open piston of the sleeve and a second sensor 402b for determining a closed position of the sleeve. The position sensor may also comprise a linear velocity displacement transducer (LVDT) switch, which would indicate an open position, a closed position, and a range of positions therebetween. The motor 325 preferably has a sensor or appropriate electronics for determining the current drawn by the motor. In a preferred embodiment, the valve works in conjunction with a controller 360 that determines information related to a condition of the valve, such as the valve opening speed, valve closing speed, valve position, motor current draw, upstream pressure, downstream pressure, differential pressure across the valve, flow through the valve, direction of flow through the valve, whether the valve is open or closed, or other conditions. The controller 360 utilizes data from the sensors to provide information to operators of the system.

In a preferred embodiment, the controller 360 comprises a computer, including a processor 370 and preferably one or more memory storage devices. The processor preferably comprises a digital signal processor. The memory storage devices preferably include a temporary memory storage device 372, such as random access memory (“RAM”), and a long-term memory 374, such has a hard drive, optical storage drive, magnetic tape, or other device. An operator interface 368 and data entry mechanism is also preferably included so that the operator can make requests of the system, enter information and receive information. For example, may include a keyboard, mouse, microphone for accepting voice commands, or other device. The operator interface 368 desirably includes a monitor or other screen for presenting visual information. The information desirably relates to the condition of the valve, such as the valve opening speed, valve closing speed, valve position, motor current draw, upstream pressure, downstream pressure, differential pressure across the valve, flow through the valve, direction of flow through the valve, whether the valve is open or closed, or other conditions. In addition, the controller is preferably arranged to receive a command from an operator concerning the position of the valve. The operator interface 368 includes a component for connecting the processor and memory storage devices to a keyboard and monitor. Such interfaces include T-base 10/100, two/four wire serial, discrete signal interfaces, analog signal interfaces and wireless.

The controller 360 interacts with the motor 325 to effectuate the operator's command. For example, the controller 360 preferably comprises a motor driver 366 connected to a primary power interface 362 and to the processor 370 so as to effectuate commands from the operator interface 368. The motor driver 366 is connected to the motor 325 to send commands to the motor 325 to move the valve 300 to the desired position, based upon the operator's command. The motor driver may comprise a mechanical or electronic component, may comprise software, or a combination of the foregoing. The motor 325 interacts with the shaft 324 to drive the first bevel gear 326. The gear 326 interacts with the second bevel gear 328, which rotates in response to the driving force of the motor. Due to rotation of the second shaft 330, to which the second bevel gear 328 is connected, the threaded housing translates along the second shaft 330. Movement of the threaded housing 334 moves the movable piston sleeve 340 in either direction, as the movable piston sleeve 340 is connected to the threaded housing 334 through the web 338. The motor may be connected to a primary power source through the primary power interface 362, or may be connected to a power source directly. The primary power for the valve 300 may comprise a generator, battery, solar source and other sources known in the art. The primary power interface 362 preferably comprises a hardware component.

In a preferred embodiment, the controller 360 is programmed to periodically monitor the system. For example, the controller may be arranged to monitor for increases in pressure within the passage 312. Preferably, the controller is programmed to command appropriate action, such as moving the piston sleeve, or other movable valve element, to a position for reducing pressure. The controller may be programmed to respond to any condition of the valve, based upon data from the sensors. In addition, the controller is preferably arranged to close the valve as quickly as possible, without generating water hammer within the passage 312. As is known in the hydraulic arts, the rapid shutting of a valve can cause the fluid to transmit a pressure wave down the conduit to other parts in the fluid handling system. Such effects can damage the system and cause dangerous accidents. In a preferred embodiment, the controller 360 is programmed so that the motor 325 continues to run for a predetermined period of time after closing the valve, until a predetermined motor current value is reached. Preferably, the motor 325 provides a predetermined load on the valve upon closing to reduce the incidence of leakage at the seat 344. Various other operations may be programmed for the valve, based upon data from the sensors, or other information regarding the system.

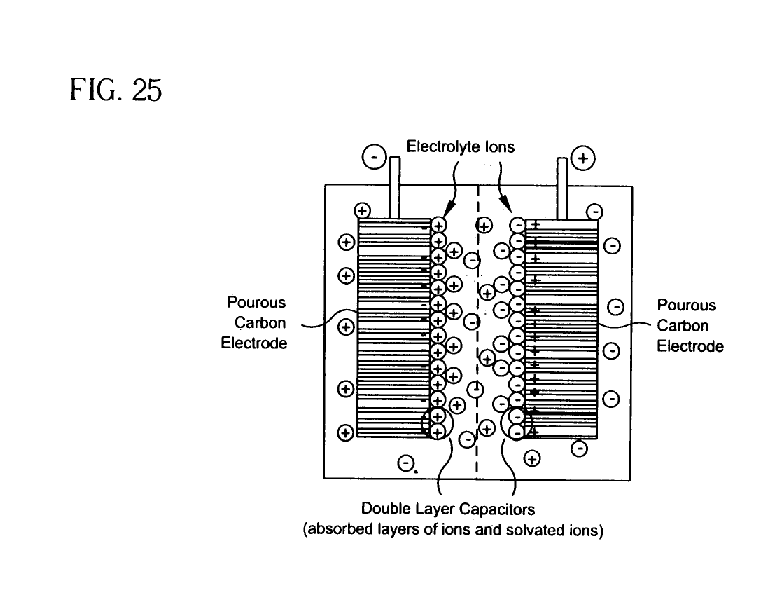

In preferred embodiments, the system includes a backup power supply 364 for operating the valve 300. The backup power supply 364 is preferably sufficient to operate the valve 300 for at least several opening and closing cycles, in the event that the primary power is lost. The backup power supply 364 may include one or more solar cells, generators, batteries, and other power sources. In a preferred embodiment, the backup power supply 364 comprises a bank of supercapacitors. Merely by way of example, a supercapacitor is schematically shown in FIG. 25. The supercapacitor has a pair of porous carbon electrodes placed in an electrolytic material. The electrolytes may comprise an organic or aqueous electrolyte. Either a symmetrical capacitor or an asymmetrical capacitor, having metal for one of the electrodes may be used. The electrodes may comprise any high surface area electrode. At least experimental examples of supercapacitors generating 25 kWh/m3 are available. Other backup power systems may be utilized, such as pumped hydroelectric, compressed air, various types of batteries, such as lithium ion, nickel cadmium, lead acid, etc. Mechanical systems such as high energy fly wheels may be used. In embodiments incorporating supercapacitors, the following companies supply supercapacitors: ESMA, ELIT Co., NESS Capacitor Co., Limited Power Cache, and SAFT. Maxwell Technologies is also a company that manufactures ultracapacitors that may be used in a backup power supply.

The memory storage devices and processor may comprise one or more components and may be hard-wired or under the control of programs for performing the functions of the controller and for performing desired calculations. The components for the memory storage devices and processor may comprise general purpose components, or specially designed components for the particular system. The controller 360 is preferably arranged to receive signals from a plurality of sensors incorporated within the valve assembly. These sensors preferably include one or more of the following: a pressure sensor for the first side of the passage, a pressure sensor for the second side of the passage, a sensor for determining whether the valve is in the closed position, and a position sensor for determining the position of the piston sleeve. The sensors may comprise transducers. The closed position sensor may comprise a limit switch. The valve position sensor may comprise a rotary position sensor, linear position sensor, a LVDT position switch, or other sensor. In one embodiment, the sensor for determining the position of the valve comprises a sensor that detects rotary movement of the first shaft 324, second shaft 330, or both. Many sensors can be used and are known to those of ordinary skill in the art.

In other embodiments, the valve is configured and arranged with a pneumatic control system. For example, the body of the valve may include a space adjacent the movable piston sleeve for admitting working fluid from a pneumatic system. The pneumatic system may include a solenoid-controlled pilot valve for delivering working fluid. The fluid is used to control the opening and closing of the sleeve. For example, one of the ports disclosed in U.S. Pat. No. 3,590,847, the disclosure of which is hereby incorporated by reference herein, may be used.

The valve components may be comprised of a variety of materials, including metals, plastics, ceramics, and elastomers. A person of ordinary skill in the art may select materials appropriate for the particular system. The seat between the valve element and the movable piston sleeve may comprise either a hard or soft seat. In addition, the person of ordinary skill in the art can pick appropriately sized components for the valve, depending upon the system in which the valve will be used.

The valve controller electronic components include a digital signal processor (“DSP”). In one embodiment, the DSP comprised a TMS 320 VC33 manufactured by Texas Instruments, Inc. The valve controller includes an analog to digital converter, a motor current command for commanding the motor, resolvers used to sense the ram position, valve position and motor position, pressure transducers and conditioners for the same, temperature transducer and conditioner for the same, motor current servo for inputting motor position information from the motor position resolver to communication with the motors, motor drive isolator for electronically disconnecting each motor, and discrete outputs for the retraction control system. A functional diagram of the channel control software is shown.

The valves are comprised of appropriate materials for hydraulic valves, such as stainless steel. The valve member, in one embodiment, is CRES Grade 316 stainless steel, whereas the seat for the valve is 440 CRES. The electromechanical actuator for the valve includes two brushless DC servo motors, spur gears, split nut ball screw assembly, valve position sensor transducers on the central gear, and “soft” mechanical stops, which may comprise Belleville washers. The valve position sensor comprises four sensors that are redundant for providing position feedback to the electronic controller for controlling and monitoring purposes. The materials for the mechanical actuator desirably comprise corrosion resistant steel or stainless steel, or similar materials. Desirably, all parts of the actuator are protected against corrosion. The gear shafts within the actuator are desirably supported by radial ball bearings. Lubricant is desirably used between the parts.

In preferred embodiments, the position of the closure is sensed and stored in an electronic storage medium during the arresting operation. As the appropriate change to the position of the closure in order to conform the craft to the desired speed reduction profile is determined, a control system determines the appropriate movement of the closure based on the stored information from the sensor.

Without balancing of the forces acting on the closure, exercising control over the closure and sensing conditions within the system to exercise such control, could not be performed.

Although the invention herein has been described with reference to particular embodiments, it is to be understood that these embodiments are merely illustrative of the principles and applications of the present invention. In other embodiments, other craft-engaging devices may be used. In place of the pendant, a net for catching the aircraft may be used. In addition, such systems may be used on landing strips located on the ground or on other surfaces. The system for resisting movement of the pendant is then located under ground. A system for decreasing the speed of a craft need not be located with respect to a surface. For example, a craft-engaging device may comprise a net stretched across an area of water or air. A number of craft may be decreased in speed, such as motor vehicles, ships, boats and various aircraft. Although certain components are described and shown in the drawings, one or more components may be used to perform the functions described. For example, where one component is shown, two or more may also be used to perform the function. For example, the functions of multiple components may be combined in a single component.

For example, although the valve is shown in a horizontal orientation in FIGS. 17A and 17B, the valve may be mounted in a in a vertical orientation in a conduit, pipe or other passage. In addition, the valve shown in FIG. 5 may be arranged in either a vertical or horizontal orientation. The valve may include more than one passage and more than one movable element in the passage. One or more of the features of the controller discussed above may be used, or the valve may be controlled using manual or pneumatic controls.

It is therefore to be understood that numerous modifications may be made to the illustrative embodiments and that other arrangements may be devised without departing from the spirit and scope of the present invention.

1. A method of controlling the operation of a valve, comprising automatically determining a condition; automatically comparing the condition to a desired condition determined by a profile; automatically determining an adjustment to the valve; and adjusting the valve during the operation of the valve.

2. The method of claim 1, wherein the step of automatically determining the condition comprises sensing the pressure at an inlet of the valve.

3. The method of claim 1, wherein the step of automatically determining the condition comprises sensing the position of a valve member of the valve.

4. The method of claim 1, wherein the profile determines desired conditions for a desired reduction in speed of a moving craft during a predetermined cycle.

5. The method of claim 4, wherein the step of comparing comprises comparing the condition to a profile for determining a desired position of the craft at a point during the cycle.

6. The method of claim 4, wherein the profile determines the desired conditions for a plurality of points during the cycle for achieving a desired reduction in speed for a predetermined stopping distance.

7. The method of claim 1, wherein the step of adjusting the valve comprises moving a valve member of the valve to a position determined by the profile.

8. The method of claim 1, wherein the steps of automatically determining the condition, automatically determining an adjustment and adjusting the valve comprise repeatedly monitoring the condition determining an adjustment and adjusting the valve.

9. The method of claim 1, further comprising receiving data concerning a value to be used in determining the adjustment, the value being selected from the group consisting of: the type of craft, the speed of the craft, and the weight of the craft.

10. The method of claim 1, further comprising selecting the profile from a plurality of profiles.

11. The method of claim 10, wherein the profile is selected depending upon a value selected from the group consisting of: the type of craft, the speed of the craft and the weight of the craft.

12. The method of claim 1, further comprising testing the operability of the valve.

13. The method of claim 1, further comprising determining the operability of at least one driver for driving movement of a valve member of the valve.

14. The method of claim 13, wherein the at least one driver comprises a first driver and a second driver and further comprising, in the event that the first driver is inoperable, connecting the second driver to the valve member.

15. A valve control system for controlling the operation of a valve, comprising:
a) at least one sensor for sensing a sensed condition;
b) a controller arranged to actively control operation of the valve during a predetermined cycle according to a predetermined profile determining a desired condition during said cycle; and
d) a driver arranged with said controller and adapted to move the valve to a position;
e) said position of the valve being adjusted during said cycle to conform said sensed condition to said desired condition.

16. The system of claim 15, wherein said at least one sensor comprises a sensor arranged for sensing said sensed condition, said sensed condition being selected from a group of conditions consisting of: a pressure at an inlet of the valve, and said position of the valve.

17. The system of claim 15, wherein said controller comprises a computer adapted to receive data from said at least one sensor concerning said sensed condition.

18. The system of claim 17, wherein said controller includes a memory storage device in which said profile is stored.

19. The system of claim 18, wherein said controller includes a processor under control of programs and a program executable by said processor, said program being adapted to compare said sensed condition with said desired condition.

20. The system of claim 19, wherein said program is arranged to determine an adjustment to said position of the valve, based upon said profile.

21. The system of claim 17, wherein said controller communicates with a driver adapted to move a valve member of the valve to an adjusted position determined by said profile.

22. The system of claim 15, wherein said profile determines said desired condition so as to achieve a decrease in the speed of a moving craft.

23. The system of claim 15, wherein said sensed condition comprises a first sensed condition, said controller being arranged to accept said first sensed condition from said at least one sensor, communicate with a driver so as to adjust said position of the valve, accept a second sensed condition from said at least one sensor and readjust said position of the valve.

24. The system of claim 23, wherein said desired condition comprises a first desired condition determined by said profile for a first point in time during said cycle and wherein said profile determines a second desired condition for a second point in time during said cycle.

25. The system of claim 15, further comprising a first driver and a second driver, said first driver and said second driver being alternately connectible with the valve and controlled by said controller, and further comprising a first monitor and a second monitor.

26. The system of claim 25, wherein said controller comprises a first controller and further comprising a first monitor for receiving data from said at least one sensor.

27. The system of claim 26, wherein said first driver, said first monitor and said first controller comprise a first channel, and further comprising a second controller and a second monitor, said second driver and said second monitor being arranged with said second controller.

28. The system of claim 27, wherein said at least one sensor comprises at least one first sensor and at least one second sensor, said at least one first sensor being connected to said first monitor and said first controller and said at least one second sensor being connected to said second monitor and said second controller.
